(19) United States
(12) Patent Application Publication
(10) Pub. No.: US 2024/0378558 A1
(43) Pub. Date: Nov. 14, 2024

(54) PROXIMITY AND COLLABORATOR-BASED SUGGESTION PROCESSING SYSTEM

(71) Applicant: Microsoft Technology Licensing, LLC, Redmond, WA (US)

(72) Inventors: Sama Hossam ZAKI, Austin, TX (US); Charlie Ricafort CHUNG, Tacoma, WA (US); Sumedha SUBRAMANIAN, Redmond, WA (US); Syed Ali HAIDER, Sammamish, WA (US)

(21) Appl. No.: 18/335,643

(22) Filed: Jun. 15, 2023

Related U.S. Application Data
(60) Provisional application No. 63/500,788, filed on May 8, 2023.

(51) Int. Cl. G06Q 10/10; G06Q 10/02

(52) U.S. Cl. CPC G06Q 10/103; G06Q 10/02

(57) ABSTRACT

A processing system identifies a set of collaborators corresponding to a user, as well as a target location corresponding to the user. The processing system identifies desk capacity and availability and ranks suggestions for available desks based upon the collaborators and the target location. The processing system detects user interaction with the ranked list of suggestions and interacts with a reservation system to allocate a desk resource to the user based on the user interaction with the suggestions.

### CROSS-REFERENCE TO RELATED APPLICATION

The present application is based on and claims the benefit of U.S. provisional patent application Ser. No. 63/500,788, filed May 8, 2023, the content of which is hereby incorporated by reference in its entirety.

### BACKGROUND

There are currently many different types of work organizations where employees work, at times, remotely (e.g., at home) and work, at times, in the office (e.g., at the company location). Given these types of hybrid work scenarios, many organizations do not have office space that corresponds one-to-one, to the number of employees of the organization. For instance, in a hybrid work scenario where employees only come into the office one day a week, the organization may only have sufficient office space to accommodate 20-30% of its employees on any given day.

At some organizations, the employees simply show up at work on a particular day (or on a random day chosen by the employee) and look for office space. In other scenarios, the organization uses an electronic scheduling system which allows an employee to reserve a desk or work location ahead of time.

The discussion above is merely provided for general background information and is not intended to be used as an aid in determining the scope of the claimed subject matter.

### SUMMARY

A processing system identifies a set of collaborators corresponding to a user, as well as a target location corresponding to the user. The processing system identifies desk capacity and availability and generates a ranked list of suggestions for available desks based upon where the collaborators are sitting and based on the target location. The processing system detects user interaction with the ranked list of suggestions and interacts with a reservation system to allocate a desk resource to the detected user based on the user interaction with the list of suggestions.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a computing system architecture.

FIGS. 2A and 2B (collectively referred to herein as FIG. 2) illustrate a flow diagram showing one example of the operation of the computing system architecture illustrated in FIG. 1.

FIG. 3 is a block diagram showing one example of a suggestion engine, in more detail.

FIG. 4 is a flow diagram illustrating one example of the operation of the suggestion engine in generating collaborator-based suggestions.

FIG. 5 is a flow diagram illustrating one example of the operation of the suggestion engine in generating location-based suggestions.

FIG. 6 is a flow diagram illustrating one example of the operation of the suggestion engine in merging and ranking the collaborator-based suggestions and the location-based suggestions.

FIGS. 7, 8, 9, 10, 11, 12, 13, 14, 15, 16, and 17 show examples of user interface displays.

FIGS. 18, 19, 20, 21, and 22 show other examples of user interface displays.

FIG. 23 is a block diagram showing one example of the computing system architecture illustrated in FIG. 1, deployed in a remote server architecture.

FIGS. 24, 25, and 26 show examples of mobile devices.

FIG. 27 is a block diagram showing one example of a computing environment that can be used in the systems and architectures shown in previous figures.

### DETAILED DESCRIPTION

As discussed above, there are many current hybrid employment scenarios in which employees work remotely part-time and come into the office part-time. Therefore, for hybrid employees, it can be difficult to find a place to work on days when the employee is working in the office. Some current organizations have reservation systems which allow a hybrid employee to book or otherwise reserve a work location (such as a desk, a conference room, etc.).

However, some organizations do not have such systems, or the hybrid employees do not use such systems. This is often because a hybrid employee, when he or she works in the office, wants to increase his or her opportunities to connect with other employees that the hybrid employee collaborates with. Therefore, some hybrid employees simply show up at work and attempt to find where their collaborators are sitting in an attempt to join them or sit near them to increase productivity.

Also, even where the organization has a reservation system, some current reservation systems make it difficult for the hybrid employee to view where other employees are sitting. For instance, if a first employee reserves a desk at a first location, and a second employee is now trying to reserve a desk, the second employee may be able to see the location where the first employee has reserved a desk. However, this type of system does little to improve the second employee's ability to reserve a desk so that the second employee can sit near his or her collaborators. Instead, such current systems still require employees to search for collaborators, attempt to find locations where groups of collaborators are sitting, and then attempt to find seating availability near that location.

The present discussion thus describes a system that identifies the collaborators of a user, either automatically or through user inputs. The present system ranks those collaborators to obtain a ranked list of collaborators. The present system also identifies a current or target location where a user wishes to work when in the office. The present system then identifies where the top ranked collaborators of the user are sitting in the office, identifies availability, and generates a set of suggested locations where the user can reserve a desk. The set of suggested locations can also be modified by the present system based upon the user's history (e.g., based upon the location where the user has historically reserved a desk, based upon the collaborators that the user has historically reserved space near, etc.).

This type of system thus greatly enhances the operation of the reservation system and reduces network traffic and data accesses performed by the reservation system. Instead of processing user interactions where a user is repeatedly hunting for different collaborators, trying to view reservations, requesting reservations, etc., the present system identifies a set of top suggestions based upon information already known about the user or input by the user (such as the user's target location and set of collaborators) and generates a ranked list of those suggestions for the user. The user can simply select one of those suggestions to reserve a work location (e.g., a desk in a desk pool), thus reducing the network traffic and processing overhead of the reservation system, and greatly enhancing the user experience.

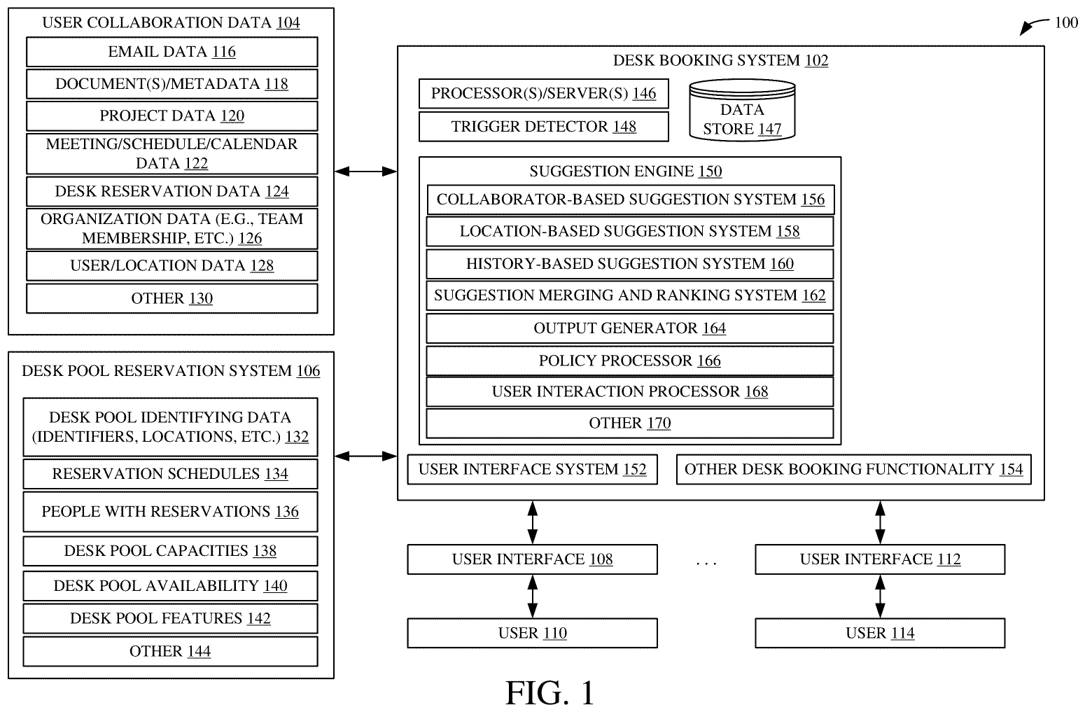

FIG. 1 is a block diagram of one example of a computing system architecture 100 in which a desk booking system 102 has access to user collaboration data 104 and desk pool reservation system 106. FIG. 1 also shows that desk booking system 102 can generate a user interface 108 for interaction by user 110, and a user interface 112 for interaction by user 114. User 110 can interact with user interface 108 to control and manipulate desk booking system 102, and user 114 can interact with user interface 112 to control and manipulate desk booking system 102.

In the example shown in FIG. 1, user collaboration data 104 may reside in a plurality of different systems (such as an email system, a calendar system, a document management system, etc.), or some or all of the data can be aggregated into a single location (such as on a single data store), or the data can be dispersed or distributed in other ways as well. The data is shown as an aggregated set of user collaboration data 104 for the sake of example only.

In the example illustrated in FIG. 1, user collaboration data 104 can include electronic mail (email) data 116, documents and corresponding metadata 118, project data 120, meeting/schedule/calendar data 122, desk reservation data 124, organization data (such as team membership, etc.) 126, user/location data 128, and other data 130. User collaboration data 104 tends to indicate the different users who collaborate with one another. For instance, if user collaboration data 104 is data corresponding to user 110, then email data 116 identifies who user 110 exchanges emails with, the frequency of the emails, the content of the emails, the urgency of the emails, and/or other items. Documents/metadata 118 may be indicative of documents that user 110 has worked on, who user 110 collaborated with in generating the document, who user 110 sent the document to, who reviewed the document, and/or other information. Project data 120 may identify the various projects that user 110 is working on, who manages those projects, team members that are assigned to the projects, etc. Meeting/schedule/calendar data 122 may identify meetings that user 110 has had or has on his or her schedule, the schedule for user 110 (such as when user 110 is in the office or working in a remote location, when user 110 has meetings or conference calls, etc.), and other user calendar data. Desk reservation data 124 may identify different desks or work locations that user 110 has reserved, the time period when the desk or work location is reserved, etc. Organization data 126 may identify where user 110 fits in an organization structure, such as who the user 110 reports to, other employees that report to user 110, the team members of user 110, the identity of the teams that user 110 belongs to, etc. User/location data 128 may uniquely identify user 110 in computing system architecture 100, along with the location where user 110 resides, the location where user 110 offices, a target location where user 110 wishes to reserve a desk or work location, or other user and/or location information.

Desk pool reservation system 106 is illustratively a system that manages desk pools (a desk pool being a cluster of desks in close proximity to one another and may also be referred to as a “neighborhood”) or other work locations that are reserved by various users in an organization. Desk pool reservation system 106 can include desk pool identifying data 132 (which includes identifiers, locations, etc.) for different desk pools, reservation schedules 134 that identify when the different desks in the different desk pools are reserved by users, people with reservations data 136 that identifies the individual users 110 and 114 that have reserved desks in the desk pools, desk pool capacities 138 which may identify a number of users that can be accommodated in a desk pool, desk pool availability 140 which may identify the remaining availability that can be reserved in a desk pool, desk pool features 142 which may identify the networking features available at a desk pool, the electronic or electric resources available, or other computing system or office resources that are available at a desk pool, and/or other items 144.

Desk booking system 102 generates user interfaces 108 and 112 which allow users 110 and 144 to book desks in a desk pool using desk pool reservation system 106. Desk booking system 102 includes one or more processors or servers 146, trigger detector 148, suggestion engine 150, user interface system 152, and other desk booking functionality 154. In the example shown in FIG. 1, suggestion engine 150 includes collaborator-based suggestion system 156, location-based suggestion system 158, history-based suggestion system 160, suggestion merging and ranking system 162, output generator 164, policy processor 166, user interaction processor 168, and/or other items 170. Trigger detector 148 detects a trigger indicating that a user 110 or 114 is attempting to reserve a desk. Suggestion engine 150 then generates a ranked list of suggested desks (e.g., workspaces) that the requesting user may wish to reserve, based upon the user's collaborators, the user's location, and the user's reservation history. User interface system 152 surfaces the ranked list of suggestions for the user and detects user interactions with the list (e.g., to see more information about a suggestion, to reserve a desk, to search for additional suggestions, etc.).

In generating the ranked list of suggestions, collaborator-based suggestion system 156 generates a set of suggested desks or work locations based upon the user's collaborators, by accessing user collaboration data 104. For instance, collaborator-based suggestion system 156 can access collaboration data 104 to identify the collaborators of the requesting user (e.g., user 110) and determine where those collaborators are sitting on the day that user 110 is attempting to reserve a desk. Location-based suggestion system 158 identifies a current or target location where user 110 would like to reserve a desk, and identifies desk pools at that location and availability at the different desk pools, and generates a suggestion list indicative of suggested desks or work locations based upon the location. History-based suggestion system 160 accesses historical reservation information for user 110 and generates a ranked list of suggestions (or modifies the ranked lists of suggestions generated by systems 156 and 158), based upon the history of user 110. Suggestion merging and ranking system 162 merges the ranked suggestion lists and ranks them to obtain a final ranked list of suggested desks or work locations and provides that list to output generator 164. Policy processor 166 can access disclosure or other security policies and ensure that the list of suggestions complies with those policies, prior to surfacing the list of the suggestions to user 110. For instance, it may be that certain employees or certain classes of employees are not to have information disclosed or surfaced about them, or some groups of employees may not wish to have their information disclosed to other groups of employees, etc. This type of restriction on disclosure may be set out in policies and policy processor 166 accesses those policies and processes the list of suggestions to ensure compliance with the policies.

Output generator 164 uses user interface system 152 to generate a user interface 108 for user 110 showing the ranked list of suggestions for user interaction. User 110 can interact with that ranked list of suggestions and user interaction processor 168 processes those user interactions. For instance, user 110 may select one of the suggestions in which case user interaction processor 168 interacts with desk pool reservation system 106 to show more information or to reserve the desk or work location identified in the selected suggestion. User 110 may provide an input requesting further suggestions, inputting further search criteria, etc. In those cases, user interaction processor 168 processes the interactions as well.

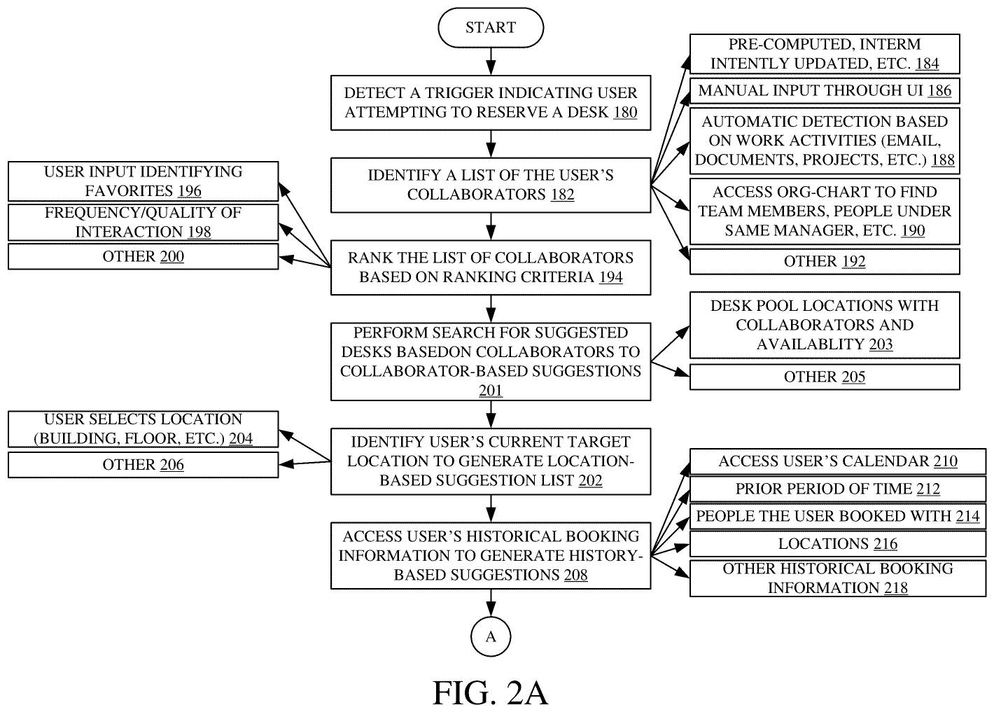

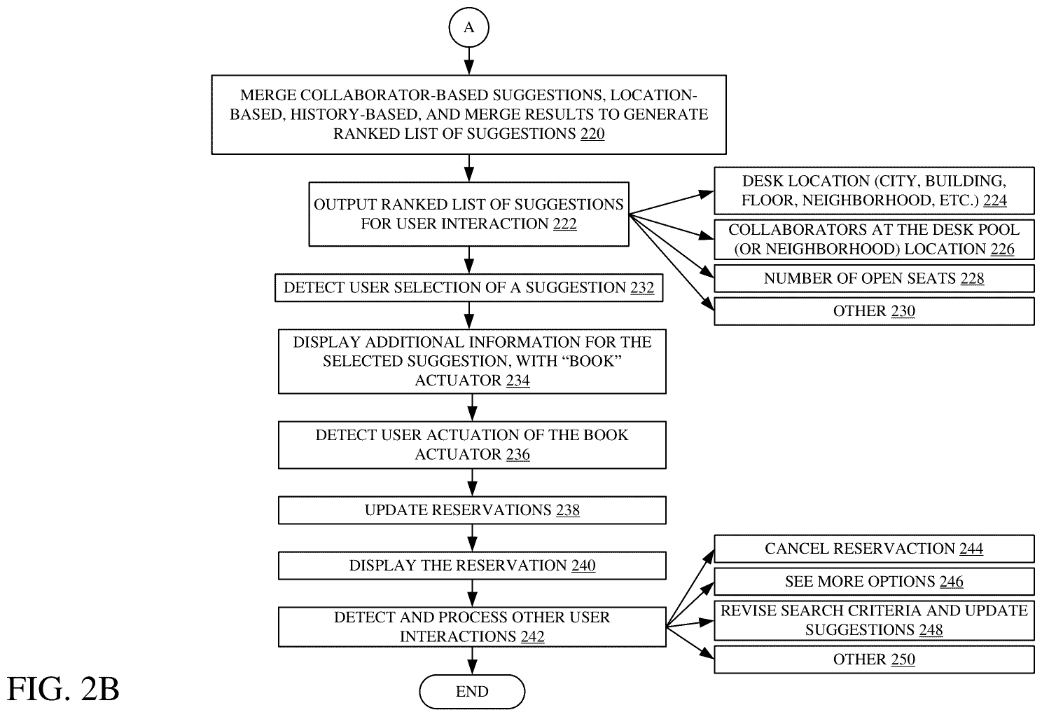

FIGS. 2A and 2B (collectively referred to herein as FIG. 2) show a flow diagram illustrating one example of the operation of desk booking system 102. Trigger detector 148 detects a trigger indicating that a user (e.g., user 110) is attempting to reserve a desk or work location. Detecting a trigger is indicated by block 180 in the flow diagram of FIG. 2. The trigger may be a user input, or another type of trigger.

Collaborator-based suggestion system 156 then identifies a list of the user's collaborators, as indicated by block 182. The list of collaborators may be pre-computed for the various users by collaborator-based suggestion system 156, as indicated by block 184. The list of collaborators may be intermittently updated, or it may be determined in response to user 110 attempting to reserve a desk or work location. Collaborator-based suggestion system 156 may use user interface system 152 to surface a user interface 108 through which user 110 can input or identify his or her collaborators, as indicated by block 186. Collaborator-based suggestion system 156 may automatically detect the collaborators of user 110 based on the work activities of user 110, as reflected by user collaboration data 104 (such as based on the user's emails, documents, projects, etc.), as indicated by block 188 in the flow diagram of FIG. 2. Collaboration-suggestion system 156 can also access organization data 126 to identify the team members of user 110, the direct reports of user 110, the manager of user 110, and those and other individuals may be added to the user's collaborator list. The user's collaborator list may be automatically identified based upon who user 110 is meeting with or has historically had conference calls with, etc. Accessing organization information to identify the user's collaborators is indicated by block 290 in the flow diagram of FIG. 2. The collaborators of user 110 can be identified in a wide variety of other ways as well, as indicated by block 192.

Collaborator-based suggestion system 156 then ranks the list of collaborators based upon any of a variety of different types of ranking criteria, as indicated by block 194 in the flow diagram of FIG. 2. For instance, user 110 may provide an input through user interface 108 ranking the collaborators, or identifying which collaborators are the user's favorites, etc., as indicated by block 196. The collaborators can be automatically ranked based upon the frequency or quality of interaction of user 110 with each collaborator, based upon analysis of user collaboration data 104, and as indicated by block 198 in the flow diagram of FIG. 2. The list of collaborators can be ranked based on a wide variety of other ranking criteria as well, as indicated by block 200.

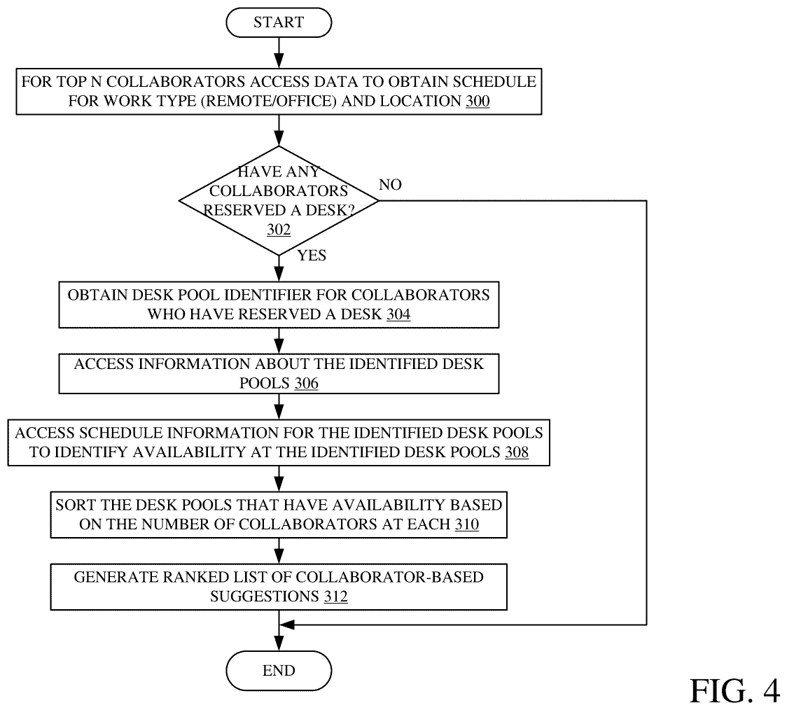

Collaborator-based suggestion system 156 also performs a search for suggested desks (or other work locations) based upon the ranked list of collaborators, to generate collaborator-based suggestions, as indicated by block 201 in the flow diagram of FIG. 2. For instance, collaborator-based suggestion system 156 may identify desk locations or desk pool locations where collaborators of user 110 have already booked desks, and that currently have availability, as indicated by block 203. The suggestions may be ranked by collaborator-based suggestion system 156 based upon the number (and identity) of collaborators in each identified desk pool, or in other ways. The collaborator-based suggestions can also be identified or generated in other ways as well, as indicated by block 205 in the flow diagram of FIG. 2. Generating collaborator-based suggestions is described in greater detail below, at least with respect to FIG. 4.

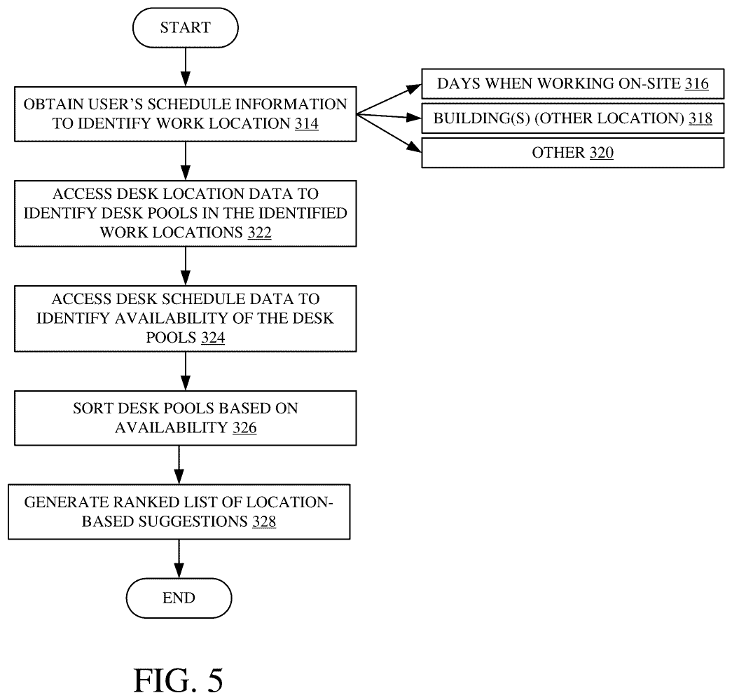

Location-based suggestion system 158 identifies the current or target location of user 110, indicative of a location where user 110 is attempting to book a workspace or desk. Location-based suggestion system 158 then generates location-based suggestions, and ranks those suggestions, based upon their location relative to the current location or target location of user 110. Identifying the user's current or target location and generating location-based suggestions is indicated by block 202. The user's current or target location can be input or selected by the user, as indicated by block 204, such as allowing the user to select a building, a floor in a building, a street address, etc. The location-based suggestions can be identified in other ways as well, as indicated by block 206. Generating location-based suggestions is described in greater detail below, at least with respect to FIG. 5.

History-based suggestion system 160 also accesses the historical booking information or historical reservation information of user 110 from user collaboration data 104 and/or desk pool reservation system 106 and generates history-based suggestions, as indicated by block 208 in the flow diagram of FIG. 2. The historical data may be accessed from the user's calendar data 122, as indicated by block 210 in the flow diagram of FIG. 2. The user's historical data can be accessed for a prior period of time (such as the prior 30 days, two weeks, etc.) as indicated by block 212. The historical data may identify who the user has reserved desks or workspaces near in the past, as indicated by block 214. The historical data may identify locations where user 110 has reserved desks or work locations, as indicated by block 216, or any of a wide variety of other historical booking information or reservation information, as indicated by block 218.

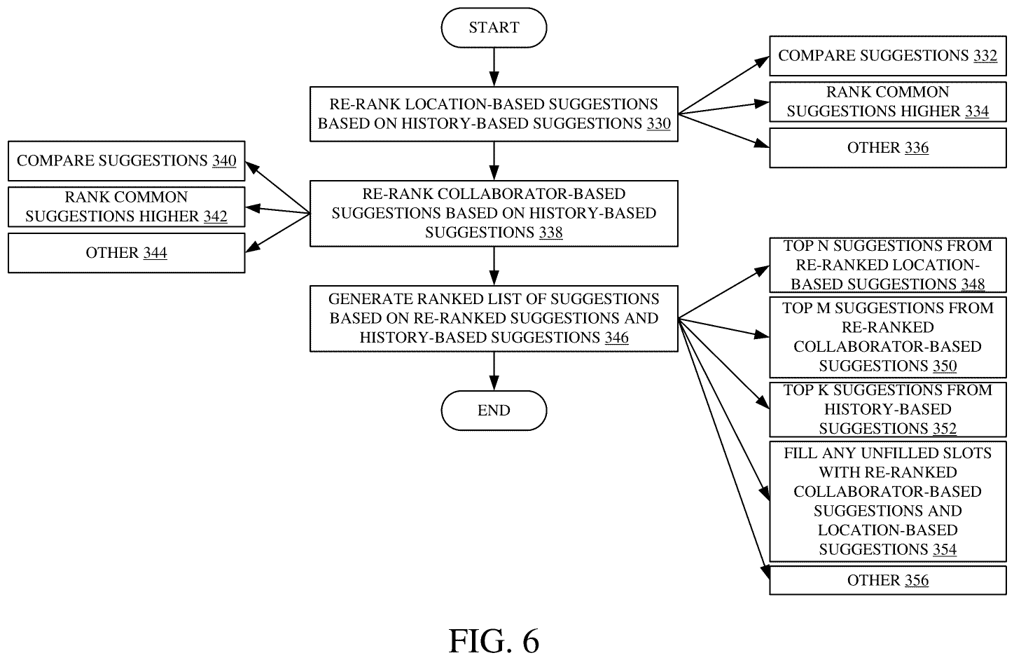

Suggestion merging and ranking system 162 then merges the collaborator-based suggestions, the location-based suggestions, and the history-based suggestions, and ranks the merged results to generate a ranked list of suggestions, as indicated by block 220 in the flow diagram of FIG. 2. Merging and ranking the results is described in greater detail below at least with respect to FIG. 6.

Output generator 164 then generates an output of the ranked list of suggestions and provides a ranked list to user interface system 152 which surfaces a ranked list as part of a user interface 108 for interaction by user 110. Outputting the ranked list of suggestions for user interaction is indicated by block 222 in the flow diagram of FIG. 2. The ranked list of suggestions may include the desk location (e.g., city, building, floor, neighborhood, etc.) as indicated by block 224. The suggestions may identify the collaborators that are at the same desk pool or neighborhood location, as indicated by block 226, the number of open seats or another capacity indicator, as indicated by block 228, and other information, as indicated by block 230.

User interface system 252 then detects user selection of one of the suggestions from the list, as indicated by block 232. User interaction processor 168 can then generate an output displaying additional information for the selected suggestion, with a “book” actuator that can be actuated by user 110 in order to reserve the suggested desk at the suggested desk pool location. Displaying the additional information with the “book” actuator is indicated by block 234 in the flow diagram of FIG. 2.

User interface system 152 then detects user actuation of the book actuator, as indicated by block 236 and interacts with desk pool reservation system 106 to update reservation schedules 134 indicating that user 110 has now reserved the suggested desk. Updating the reservations in this way is indicated by block 238 in the flow diagram of FIG. 2.

User interface system 152 then displays the reservation to user 110, as indicated by block 240, and detects any other user interactions. User interaction processor 168 can process any additional user interactions as well, as indicated by block 242. For instance, user 110 may interact with the user interface display to cancel the reservation 244, to see more options 246, to revise search criteria and update suggestions 248, and/or to perform other user interactions, as indicated by block 250.

If user 244 actuates an actuator to cancel the reservation, then user interaction processor 168 again interacts with desk pool reservation system 106 to cancel the reservation. If user 110 provides an input to see more options, then user interaction processor 168 can obtain additional suggestions generated by suggestion merging and raking system 162, and show those suggestions to user 110. If the user 110 provides an input to revise the search criteria and update suggestions, as indicated by block 248, user interface system 152 may generate a user interface display that can receive the revised search criteria so that suggestion engine 150 can generate new suggestions based upon the revised criteria. For instance, user 110 may change the target location, modify the list of collaborators, etc.

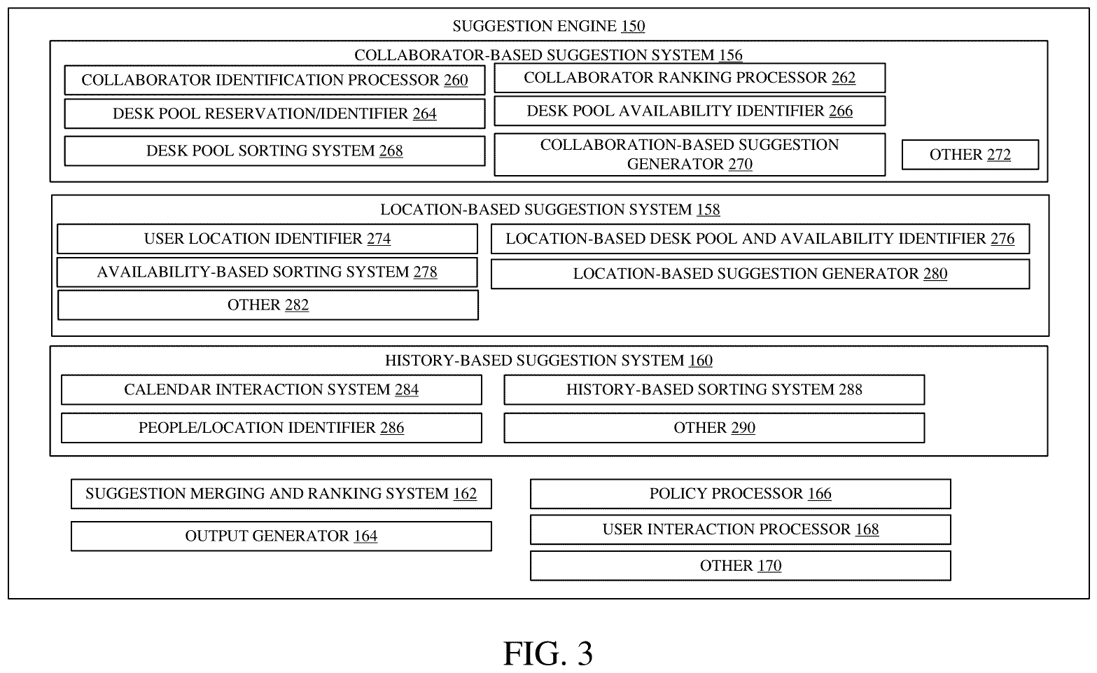

FIG. 3 is a block diagram showing one example of suggestion engine 150 in more detail. FIG. 3 shows that collaborator-based suggestion system 156 can include collaborator identification processor 260, collaborator ranking processor 262, desk pool reservation identifier 264, desk pool availability identifier 266, desk pool sorting system 268, collaboration-based suggestion generator 270, and other items 272. Location-based suggestion system 158 includes user location identifier 274, location-based desk pool and availability identifier 276, availability-based sorting system 278, location-based suggestion generator 280, and other items 282. History-based suggestion system 160 can include calendar interaction system 284, people/location identifier 286, history-based sorting system 288, and other items 290.

Collaborator identification processor 260 can obtain user collaboration data 104, and other data, and identify the collaborators of user 110. Processor 260 can receive user inputs from user 110 identifying or ranking the collaborators as well. Collaborator ranking processor 262 may rank the identified collaborators based upon those user inputs, or based upon an analysis of the quality and frequency of the interactions between user 110 and the various collaborators. Desk pool reservation identifier 264 obtains desk reservation data 124 that identifies which of the collaborators already have desks reserved for the relevant time period, and desk pool availability identifier 266 identifies the availability in the desk pools where other collaborators have reserved desks. Desk pool sorting system 268 then sorts the desk pools where collaborators have reservations, based upon the number of collaborators that have reservations in each desk pool. Similarly, the collaborators that are higher on the ranked collaborator list may be weighted more heavily than the collaborators ranked lower on the collaborator list. By way of example, it the top two highest ranked collaborators have reservations at the same desk pool, then that desk pool may be ranked higher than if three collaborators (ranked 8^{th}, 9^{th}, and 10^{th} on the ranked collaborator list), are at a different desk pool. This is just one example and desk pool sorting system 268 can sort the desk pools, based upon the number of collaborators that have reservations at the different desk pools, based upon the identity and rank of those collaborators on the collaborator list, or in other ways as well. Collaboration-based suggestion generator 270 then generates a ranked list of collaboration-based suggestions based upon the sorted desk pool results output by desk pool sorting system 268. The collaboration-based suggestions may identify the location of the desks or desk pools on the suggestions, the identity of the collaborators that are in those desk pools, the features or other data corresponding to the desk pool, etc.

User location identifier 274 identifies the target location where user 110 wishes to work. User location identifier 274 can access current location information for user 110 to identify the target location. User location identifier 274 can access profile or other information that identifies a location of user 110, or user location identifier 274 can receive a user input from user 110 identifying the target location. Location-based desk pool and availability identifier 276 accesses desk pool reservation system 106 to identify the different desk pools that have availability at the identified target location. Availability-based sorting system 278 may sort those desk pools based upon the number of available seats, or in other ways. Location-based suggestion generator 280 generates location-based suggestions, suggesting the desk pools that have availability, as sorted by availability-based sorting system 278.

Calendar interaction system 284 interacts with (e.g., searches) the meeting/schedule/calendar data 122 for user 110 to identify, historically speaking, where user 110 has reserved locations in the past. People/location identifier 286 may interact with that same data, or different data, to identify other people in the desk pools where user 110 has reserved a desk in the past. History-based sorting system 288 then generates a ranked set of history-based suggestions identifying desk locations or desk pool locations based upon the historical data (e.g., based on the frequency with which user 110 reserved a desk at a particular location, near particular collaborators, etc.).

FIG. 4 is a flow diagram illustrating one example of the operation of collaborator-based suggestion system 156, in more detail. It is first assumed that collaborator identification processor 260 has identified collaborators of user 110, and that collaborator ranking processor 262 has ranked the collaborators. Then, for the top N collaborators, desk pool reservation identifier 264 accesses the desk pool reservation system 106 to obtain the schedule data to determine whether any of the top N collaborators are working in the office, and have a desk reserved. Collaborator-based suggestion system 156 can, for instance, access user collaboration data 104 to determine the schedules of the various top N collaborators to determine when those collaborators are working remotely, when they are working in the office, and the office location where they are working. Desk pool reservation identifier 264 can then access the desk pool reservation system 106 to determine whether any of the top N collaborators already have reserved a desk. Accessing data to obtain the schedule and work type (remote/office) and work location of the top N collaborators is indicated by block 300 in the flow diagram of FIG. 4. Determining whether any of the top N collaborators have already reserved a desk is indicated by block 302.

For each of the collaborators who have already reserved a desk, desk pool reservation identifier 264 accesses desk pool reservation system 106 to obtain the desk pool identifying data 132 for the reserved desks and then desk pool availability identifier 266 accesses the reservation schedule 134 for the identified desk pools to determine which of those desk pools have availability. Obtaining the desk pool identifier for the desk pools where collaborators have already reserved a desk is indicated by block 304 in the flow diagram of FIG. 4. Accessing information about the identified desk pools (such as capacities, locations, desk pool features, etc.) is indicated by block 306. Accessing the reservation schedules 134 to determine which of the desk pools have availability is indicated by block 308 in the flow diagram of FIG. 4.

Desk pool sorting system 268 then sorts the desk pools, which have availability, based upon the number of collaborators that have reservations in the desk pools. For instance, where a first desk pool has five collaborators with reservations, that desk pool will be sorted higher than a desk pool which has only two collaborators with reservations. Sorting the desk pools that have availability based on the number of collaborators at each desk pool is indicated by block 310 in the flow diagram of FIG. 4. As discussed above, the desk pools may also be sorted based on the identity of the collaborators at each desk pool.

Collaboration-based suggestion generator 270 then generates a ranked list of collaborator-based suggestions based upon the sorted desk pools provided by desk pool sorting system 268. The collaborator-based suggestions may identify the location of the desk pool, the other collaborators that have reservations at that desk pool, the features of the desk pool, the availability in the desk pool, etc. Generating a ranked list of collaborator-based suggestions is indicated by block 312 in the flow diagram of FIG. 4.

FIG. 5 is a flow diagram illustrating one example of the operation of location-based suggestion system 158, in more detail. User location identifier 274 first accesses the user's schedule/calendar information 122 from user collaboration data 104 in order to identify the user's location (either the user's current location, the user's normal office location, the user's target location-which may be input by the user or determined in other ways, etc.). Obtaining the user's schedule information to identify the user's location is indicated by block 314 in the flow diagram of FIG. 5. Among other things, the user's schedule information may identify the days when the user is working onsite (e.g., in the office) as indicated by block 316. The user's schedule information may identify the buildings (or other locations) where the user desires to work, as indicated by block 318. The user's schedule information can identify a wide variety of other information as well, as indicated by block 320.

Location-based desk pool and availability identifier 276 then accesses the desk pool location data 132 in desk pool reservation system 106 to identify desk pools in the identified work location, as indicated by block 322 in the flow diagram of FIG. 5. Identifier 276 also accesses the desk pool availability data 140 to determine which of the desk pools at the desired location have availability, as indicated by block 324 in the flow diagram of FIG. 5. Availability-based sorting system 278 then sorts the desk pools based upon their availability, as indicated by block 326 in the flow diagram of FIG. 5. For instance, a desk pool at the desired location that has more availability may be sorted higher than a desk pool at the desired location that has less availability and others may be used as well. This is just one way of sorting the desk pools based on availability. Location-based suggestion generator 280 then generates a ranked list of location-based suggestions, as indicated by block 328 in the flow diagram of FIG. 5. The location-based suggestions may identify similar information as the collaborator-based suggestions generated by collaboration-based suggestion generator 270, or the location-based suggestions may have different information, a subset of information, additional information, etc.

FIG. 6 is a flow diagram illustrating one example of the operation of suggestion merging and ranking system 162, in more detail. It is first assumed that suggestion merging and ranking system 162 has received the ranked list of suggestions from collaborator-based suggestion system 156 and the ranked list of suggestions from location-based suggestion system 158. Suggestion merging and ranking system 162 then accesses history-based suggestion system 160 to obtain history-based suggestions. As mentioned above, history-based suggestion system 160 uses calendar interaction system 284 to access the past meeting/schedule/calendar data 122 for user 110 to see where user 110 has reserved desks in the past, which collaborators have been located in the same desk pool as user 110 in the past, etc. People/location identifier 286 identifies the location of those prior reservations and identifies the collaborators at the reserved desk pools. History-based sorting system 288 then sorts the location and collaborators from the prior desk reservations of user 110 to identify where user 110 has most often reserved a desk (in terms of location), as well as the collaborators that user 110 has most often shared a desk pool with, historically. It will be noted that history-based suggestion system 160 can identify this information over a predefined historical period (such as over the last 30 days, over the last two weeks, etc.) or in other ways.

Suggestion merging and ranking system 162 then re-ranks the location-based suggestions from location-based suggestion system 158, based upon the history-based suggestions, as indicated by block 330 in the flow diagram of FIG. 6. For instance, suggestion merging and ranking system 162 can compare the location-based suggestions generated by system 158 with the historical locations where user 110 has reserved desks. Comparing such suggestions is indicated by block 332 in the flow diagram of FIG. 6. Suggestion merging and ranking system 162 can then rank the common suggestions (the location-based suggestions generated by system 158 that also match the locations where user 110 has previously reserved a desk) higher than location-based suggestions which do not match any historical suggestions. Ranking common suggestions higher is indicated by block 334 in the flow diagram of FIG. 6. Suggestion merging and ranking system 162 can re-rank the location-based suggestions in other ways as well, as indicated by block 336 in the flow diagram of FIG. 6.

Suggestion merging and ranking system 162 also re-ranks the collaborator-based suggestions based upon the history-based suggestions, as indicated by block 338 in the flow diagram of FIG. 6. Again, suggestion merging and ranking system 162 can compare the collaborators in the collaborator-based suggestions to the collaborators that user 110 has reserved a desk within the past, to identify the collaborator-based suggestions that have the same or similar collaborators. Comparing the suggestions in this way is indicated by block 340 in the flow diagram of FIG. 6. Suggestion merging and ranking system 162 can then rank the collaborator-based suggestions which have collaborators that match the history-based suggestions higher than the collaborator-based suggestions that do not match the collaborators in the history-based suggestions. Re-ranking the collaborator-based suggestions in this way is indicated by block 342 in the flow diagram of FIG. 6. Suggestion merging and ranking system 162 can re-rank the collaborator-based suggestions in other ways as well, as indicated by block 344.

Suggestion merging and ranking system 162 then generates a ranked list of suggestions based upon the re-ranked suggestions and based on the history-based suggestions, as indicated by block 346 in the flow diagram of FIG. 6. For instance, system 162 can take the top N suggestions from the re-ranked location-based suggestions as indicated by block 348, and the top M suggestions from the re-ranked collaborator-based suggestions, as indicated by block 350, as well as the top K suggestions from the history-based suggestions, as indicated by block 352. System 162 can generate the list with the collaborator-based suggestions higher than the location-based suggestions, or vice versa. Similarly, system 162 can fill any unfilled slots (e.g., if there are no history-based suggestions, for example) with re-ranked collaborator-based suggestions and/or re-ranked location-based suggestions, as indicated by block 354. System 162 can be configured to output a ranked list of suggestions having a predefined number of suggestions, having a dynamically variable number of suggestions, or in other ways, as indicated by block 356 in the flow diagram of FIG. 6.

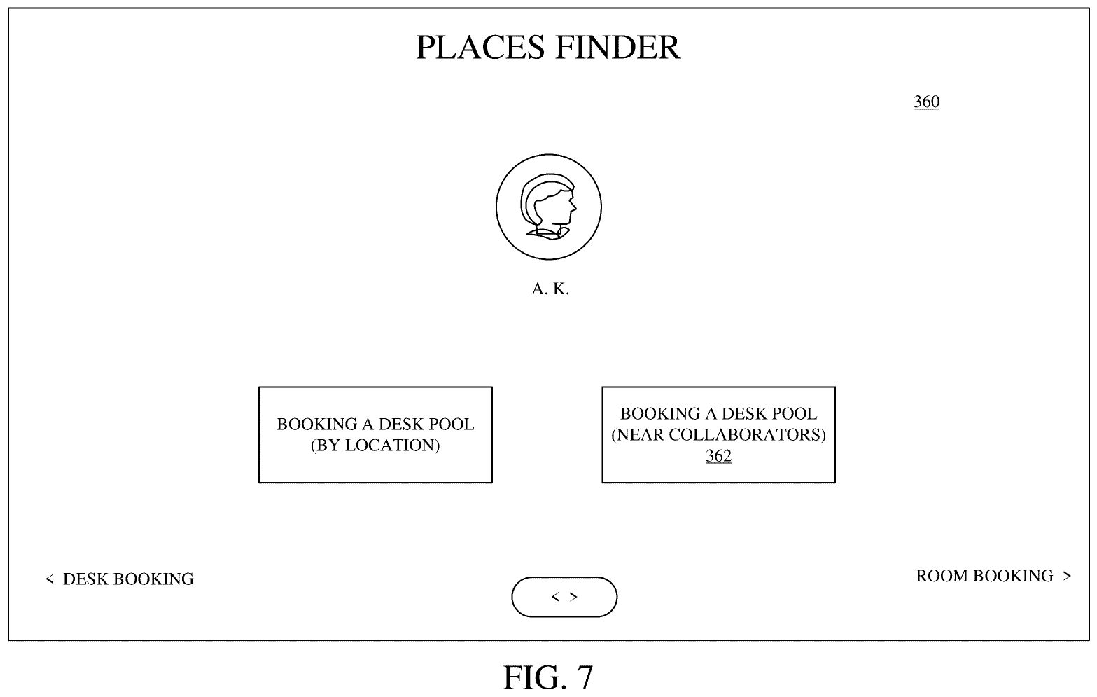

FIGS. 7-17 show examples of user interface displays that can be generated by desk booking system 102 in allowing user 110 to book a desk in a desk pool, based upon the collaborators of user 110 that have already reserved a desk in that desk pool.

FIG. 7 shows a first user interface display 360 that has an actuator 362 that user 110 can actuate in order to begin the process of booking a desk in a desk pool near the collaborators of user 110. When user 110 actuates actuator 162, then trigger detector 148 detects that user 110 wishes to make a reservation near his or her collaborators.

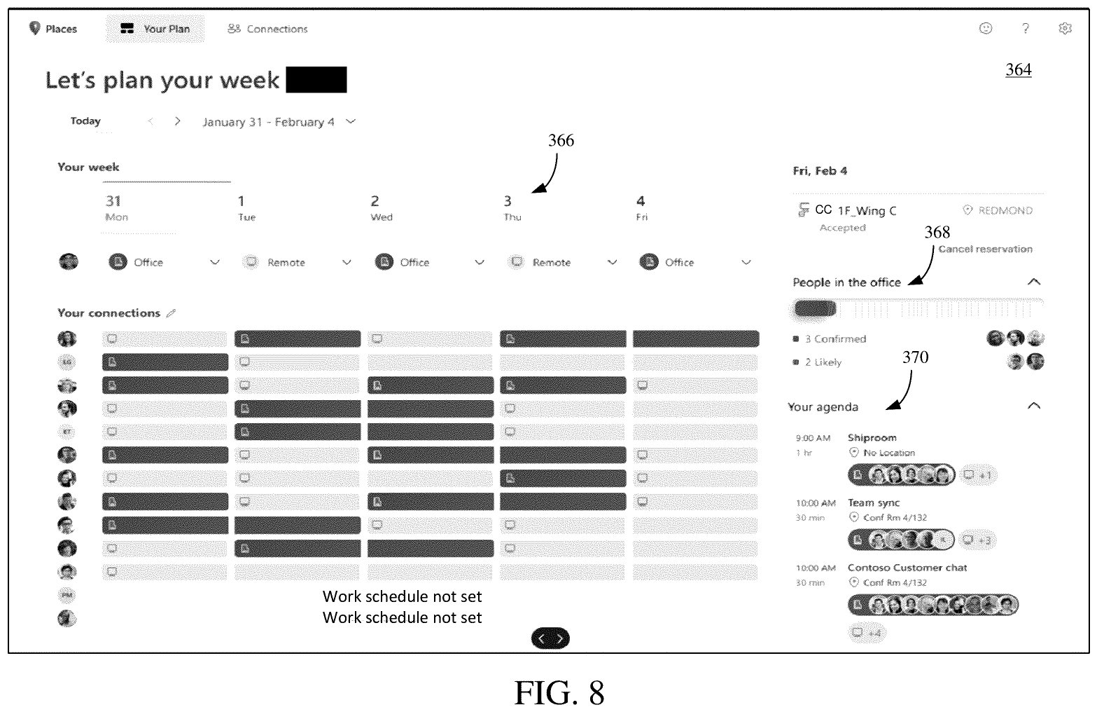

Therefore, user interaction processor 168 can generate a user interface through user interface system 152 such as user interface 364 shown in FIG. 8. In the example shown in FIG. 8, user interface display 364 shows a calendar section 366 that displays the calendar information for user 110. Similarly, display 364 shows a people identifier section 368 that identifies collaborators of user 110 who will be in the office on a selected day, that is selected in calendar section 366. Display 364 also illustratively includes an agenda section 370 that shows the agenda of user 110 for the selected day. User 110 can select one of the days on calendar portion 366 to book a desk in a desk pool on the selected day. For instance, assume that on the user interface display 364 shown in FIG. 8, the user selects Friday, February 4^{th}.

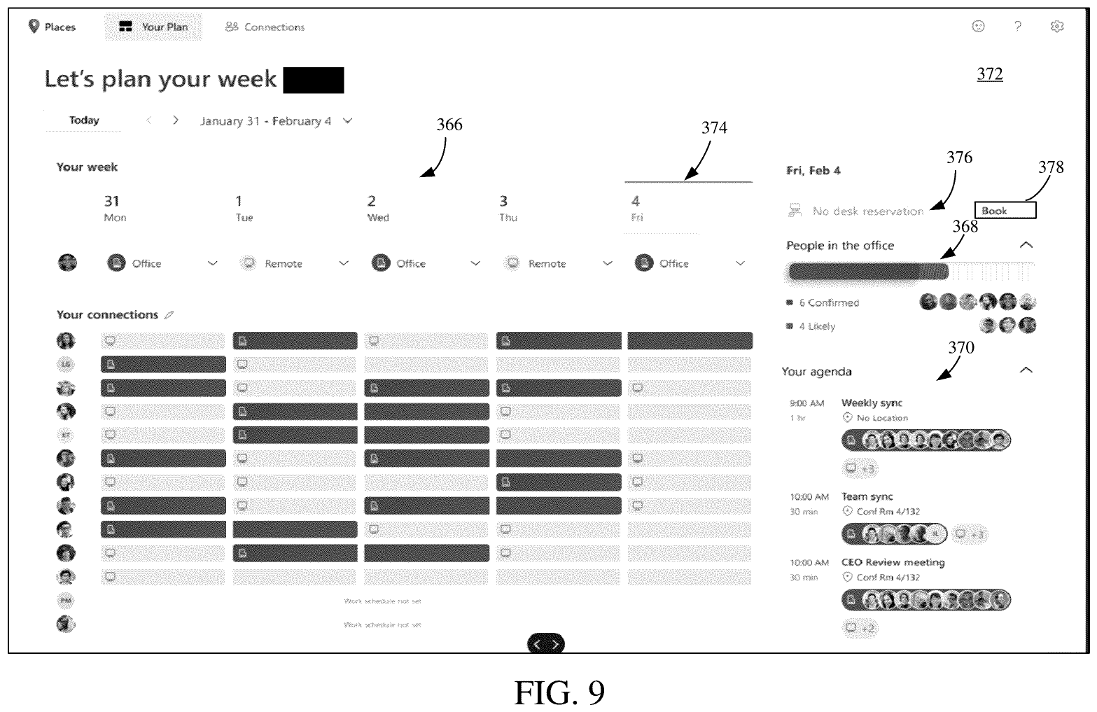

In that case, desk booking system 102 can generate a user interface display such as user interface display 372 shown in FIG. 9. User interface display 372 is similar to user interface display 364 shown in FIG. 8, and similar items are similarly numbered. However, user interface display 372 now shows that the date Friday, February 4^{th}, has been selected, as indicated generally at 374 in FIG. 9. Also, sections 368 and 370 have been updated to show information corresponding to the selected date (Friday, February 4^{th}). Also, a desk booking display portion 376 shows that user 110 has not booked a desk (or made a desk reservation) for Friday, February 4^{th}. Display portion 376 includes a “book” actuator 378. User 110 can actuate the “book” actuator 378 to obtain a list of suggestions that is generated by systems 156, 158, and 160, and that is merged and ranked by system 162 and output using output generator 164.

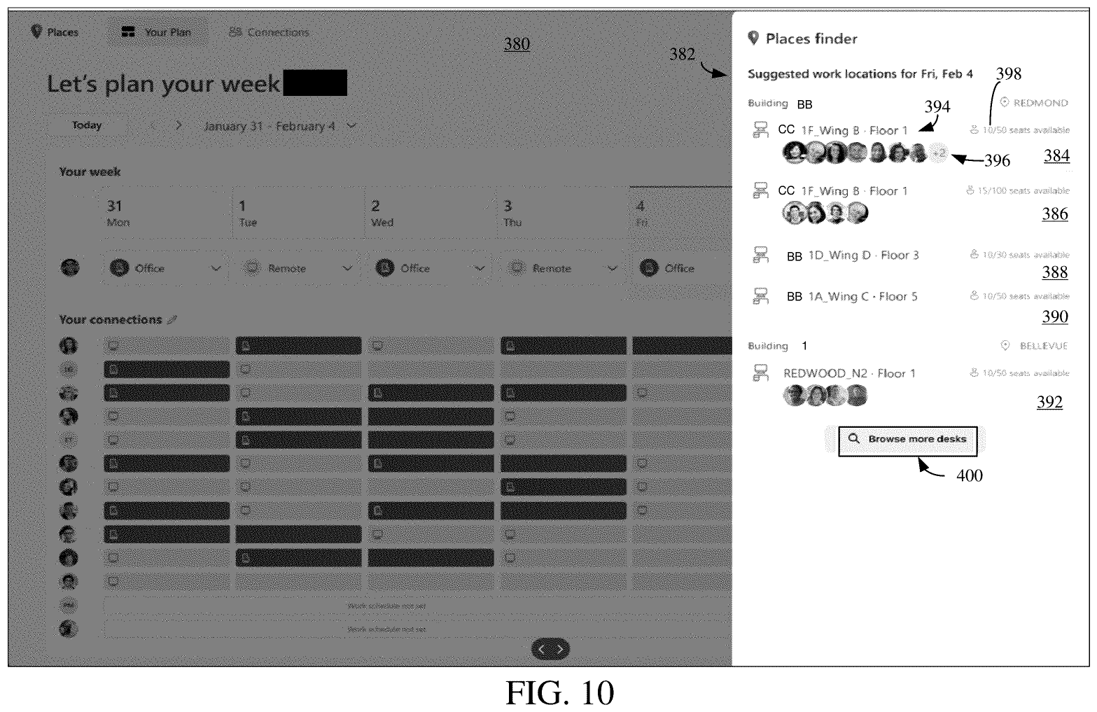

In the present example, when the user 110 actuates “book” actuator 378, desk booking system 102 can generate a user interface display, such as display 380 illustrated in FIG. 10. User interface display 380 now shows that a suggestions panel 382 is displayed which displays a plurality of different suggestions 384, 386, 388, and 390 all in building 32. Each suggestion illustratively shows the location of the suggested desk or desk pool, the number of the user's collaborators that currently have reservations at that desk pool, as well as the capacity and current availability of the desk pool. For instance, suggestion 384 includes a location section 394 that shows the specific location of the suggested desk pool, and a collaborator section 396 that identifies the collaborators of user 110 that currently have reservations in the suggested desk pool. A capacity/availability portion 398 displays the overall capacity and the availability in the suggested desk pool.

Suggestions panel 382 also shows a suggested desk pool 392 at a different location (e.g., at building 13 instead of building 32). In addition, panel 382 includes an actuator 400 that allows user 110 to browse additional suggested desk pools.

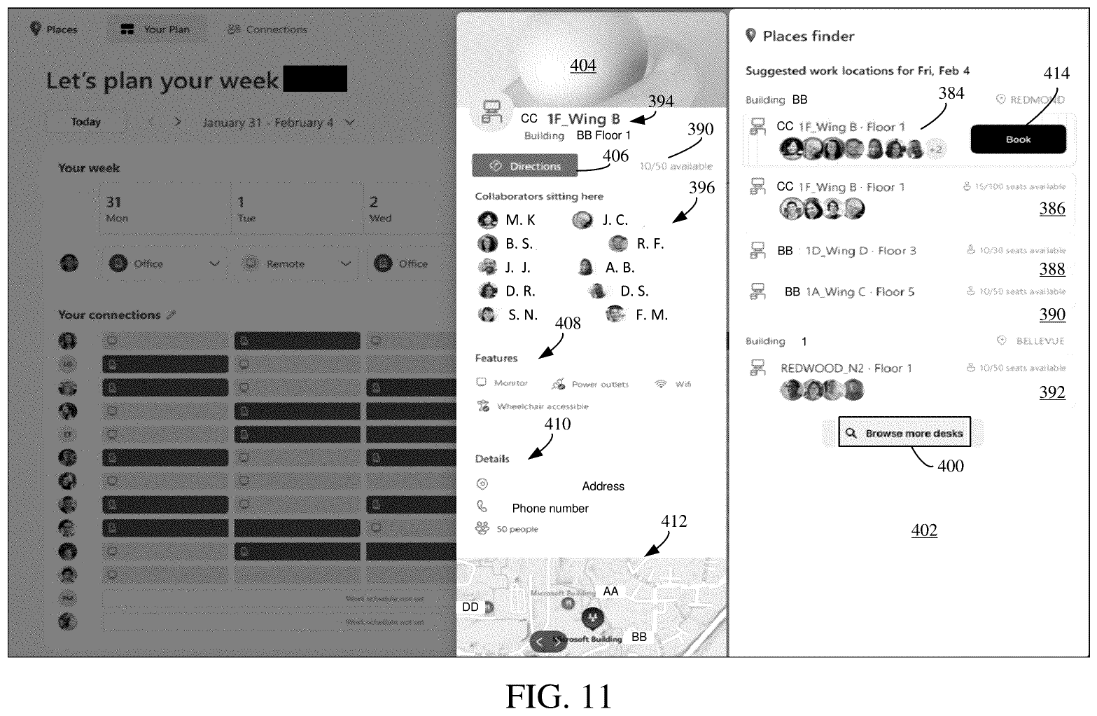

It is assumed that each of the suggestions 384-392 are displayed along with, or as part of, a user actuatable display element (such as a link or button, etc.). Therefore, the user can actuate one of the suggestions 384-392 (such as by touching it, clicking on it, etc.) in order to commence booking that suggestion. For example, assume that user 110 actuates the box corresponding to suggestion 384. In that case, desk booking system 102 can generate a user interface display, such as display 402 illustrated in FIG. 11. Some of the items in FIG. 11 are similar to those shown in FIG. 10, and they are similarly numbered.

However, FIG. 11 shows that display 402 now includes a detailed suggestion panel 404 which shows additional details for the selected suggestion 384. Thus, panel 404 includes the location portion 394 which shows the location of the desk pool, the capacity and availability section 398 which shows the capacity and availability at the desk pool, the collaborators section 396 which shows all collaborators that have reservations in that desk pool, etc. In addition, panel 404 includes a direction actuator 406 which can be actuated by user 110 to see directions to the desk pool. Panel 404 also includes a feature section 408 that shows some of the features that are available in the desk pool, and a details section 410 that may show additional details about the desk pool. Panel 404 can also include a map section 412 that shows a map of the location of the desk pool.

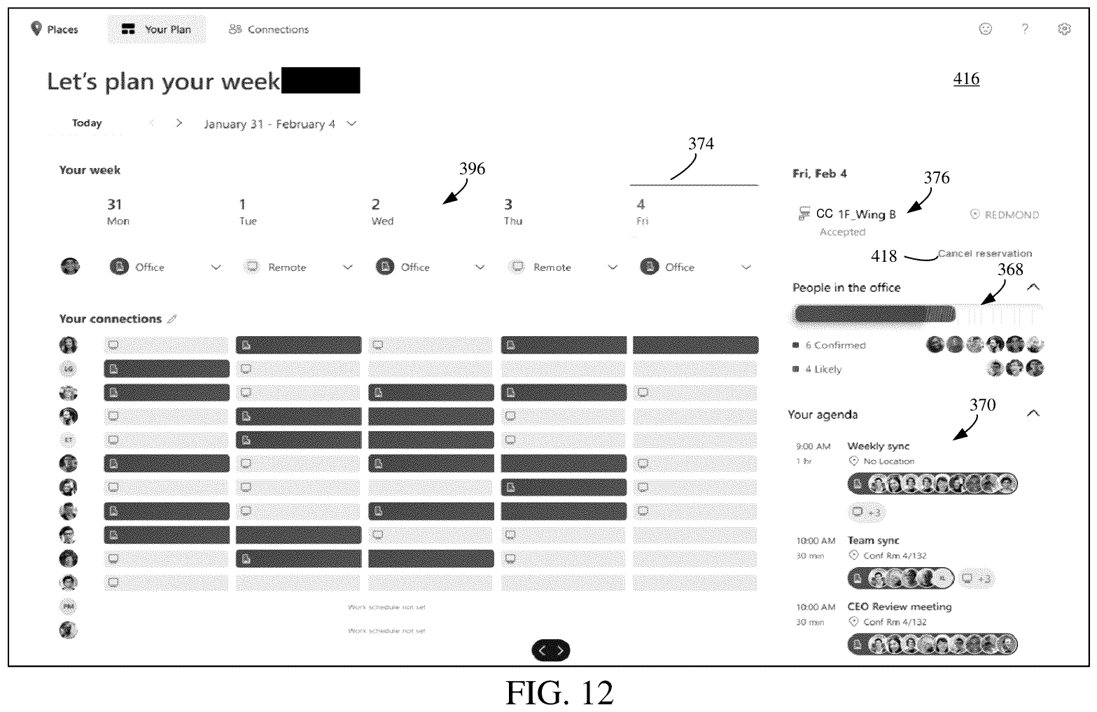

Further, user interface display 402 now displays a “book” actuator 414 on the selected suggestion 384. User 110 can actuate “book” actuator 414 to book a desk at the desk pool represented by detailed suggestion panel 404. In that case, desk booking system 102 can generate a user interface display such as user interface display 416 illustrated in FIG. 12.

It can be seen that user interface display 416 is similar to user interface display 372 illustrated in FIG. 9, and similar items are similarly numbered. However, user interface display 416 now shows that desk reservation section 376 displays the reserved desk location. Also, section 376 includes a cancel reservation actuator 418 which can be actuated by user 110 to cancel the desk reservation. If user 110 actuates the cancel reservation actuator 418, then desk booking system 102 generates a user interface display which is the same as that shown in FIG. 9. The user 110 can then actuate the book actuator 378 in FIG. 9 to again begin to book a desk and the system generates a display such as display 380 shown in FIG. 10.

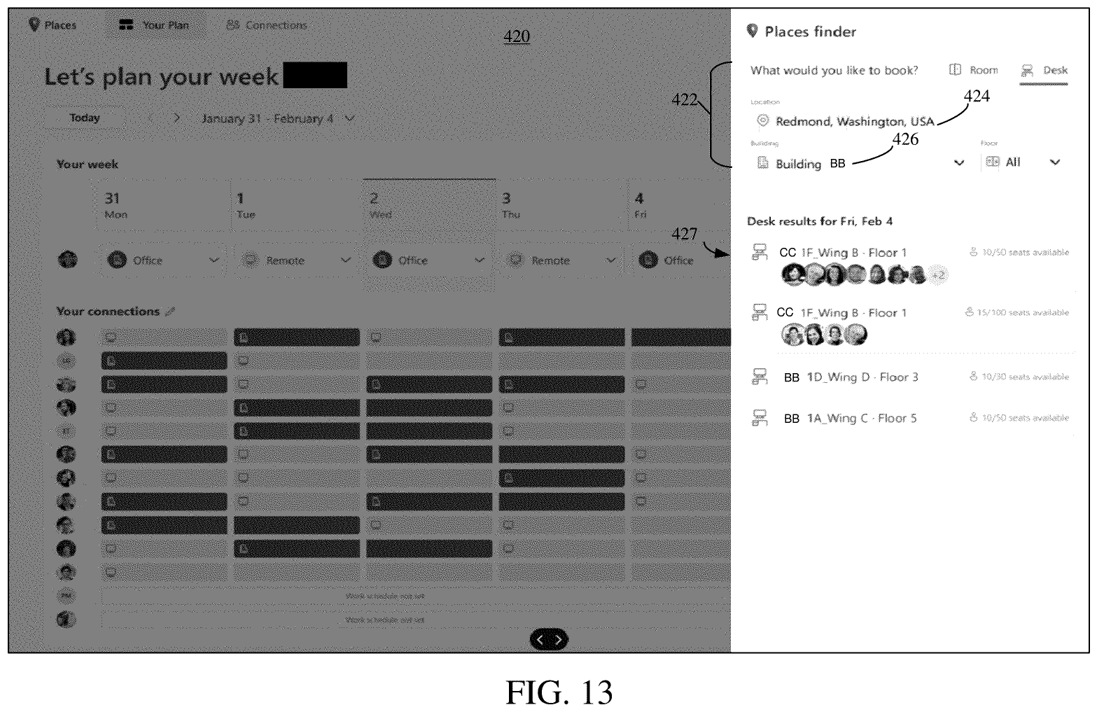

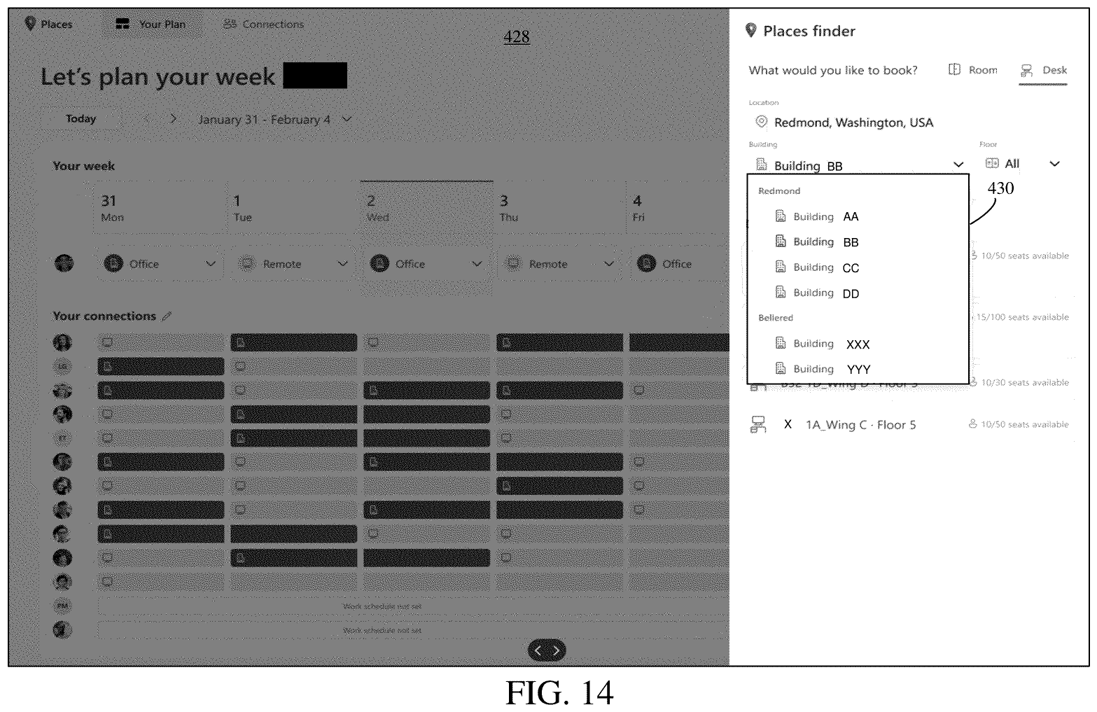

Assume, in FIG. 10, that user 110 now actuates the “browse more desks” actuator 400. In that case, desk booking system 102 can generate a display such as display 420 shown in FIG. 13. Display 420 includes an editable location section 422 that allows user 110 to change the location or search criteria that identifies where desks are being sought. For instance, location section 422 has a city field 424 and a building field 426, although these are provided only for the sake of example and other fields could be used. In FIG. 13, it is assumed that user 110 actuates the building actuator 426 in which case desk booking system 102 generates an interface display such as user interface display 428 illustrated in FIG. 14. FIG. 14 shows that a drop-down menu 430 has been generated, listing buildings in different cities. FIG. 14 shows that building 32 is currently selected, but allows user 110 to select any of the other displayed buildings as well.

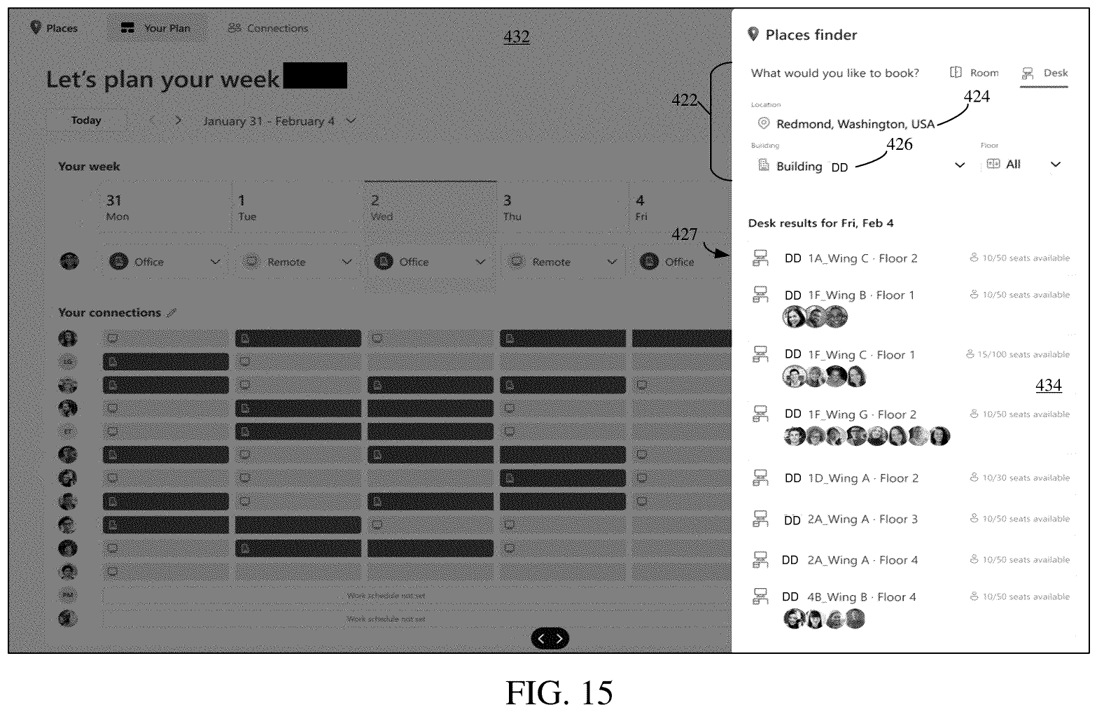

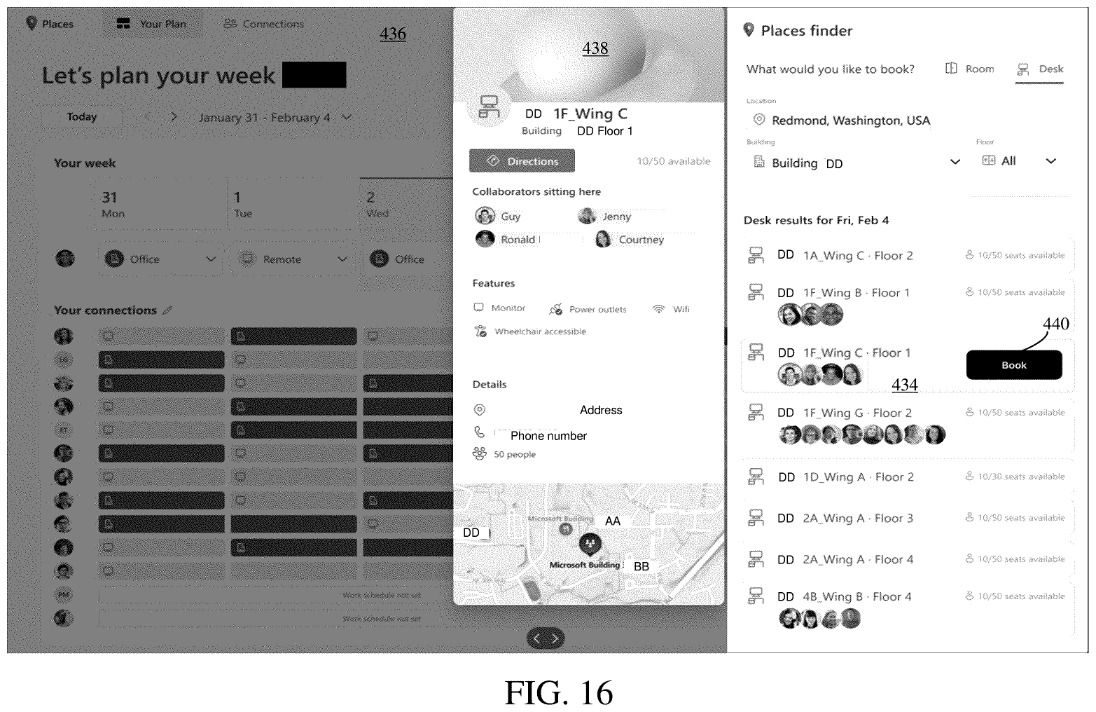

Assume, for example, in FIG. 14, that user 110 selects building 34 from drop-down menu 430. In that case, system 102 generates a user interface display such as user interface display 432 shown in FIG. 15. Display 432 is similar to display 420 illustrated in FIG. 13, and similar items are similarly numbered. However, the desk results section 427 shown in FIG. 15 now shows desk pools with availability in building 34, instead of building 32. Each of the desk suggestion results in section 427 is illustratively an actuatable display element. Therefore, user 110 can select one of desk suggestion results in display portion 427 to continue with booking a reservation. Assume, for instance, that user 110 actuates display element 434. In that case, desk booking system 102 generates a display such as display 436 illustrated in FIG. 16. Display 436 includes a detailed panel 438 that shows details of the suggestion 434, similar to the details shown on panel 404 discussed above with respect to FIG. 11. FIG. 16 shows that a “book” actuator 440 is also displayed so that user 110 can continue booking a desk in the suggested desk pool 434 by actuating book actuator 440.

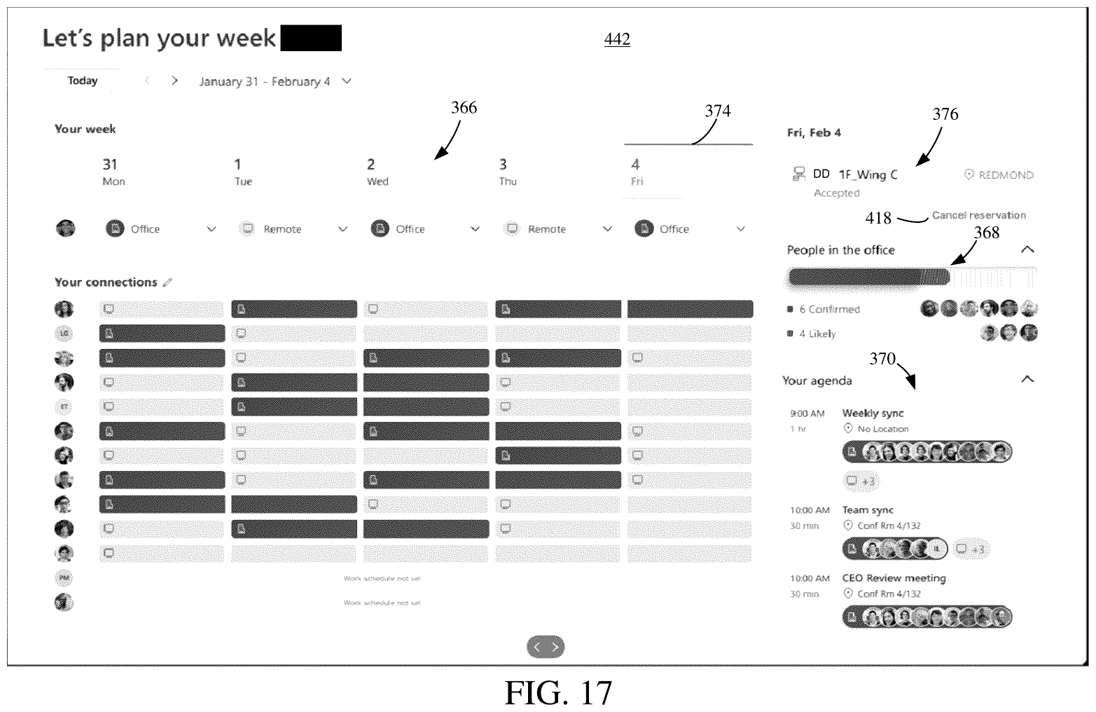

Assume that user 110 actuates book actuator 440 shown in FIG. 16. In that case, desk booking system 102 generates a display such as display 442 illustrated in FIG. 17. It can be seen that display 442 is similar to display 416 shown in FIG. 12, and similar items are similarly numbered. However, the location of the desk reservation shown in section 376 now corresponds to the selected suggestion 434 from FIG. 16.

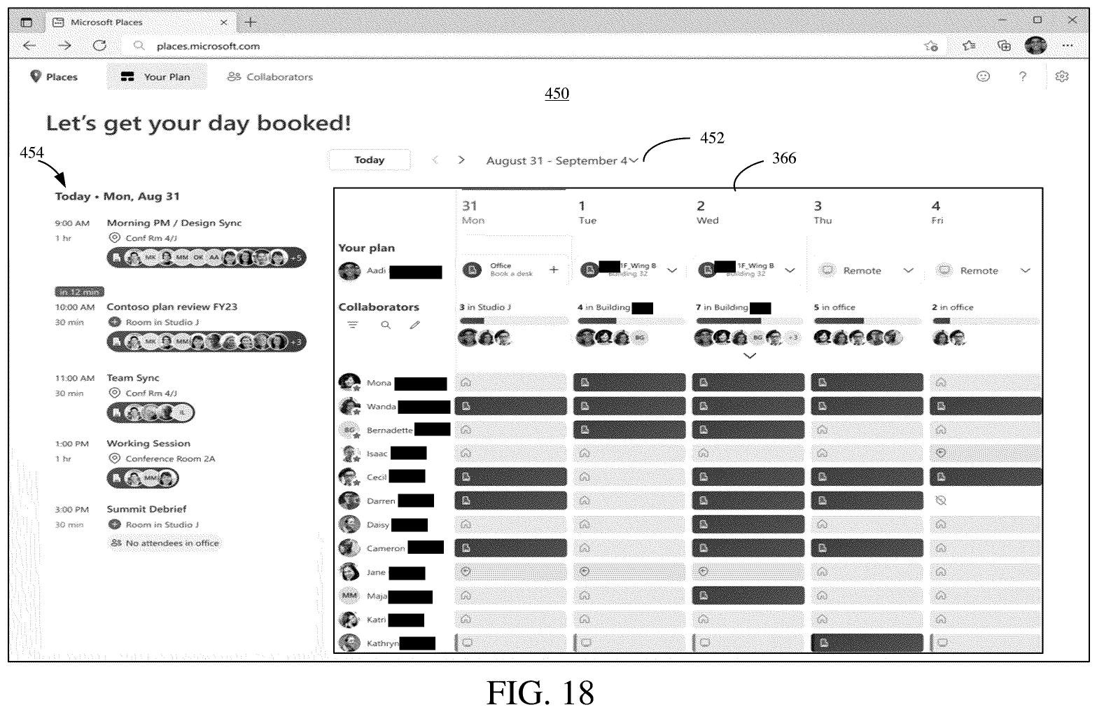

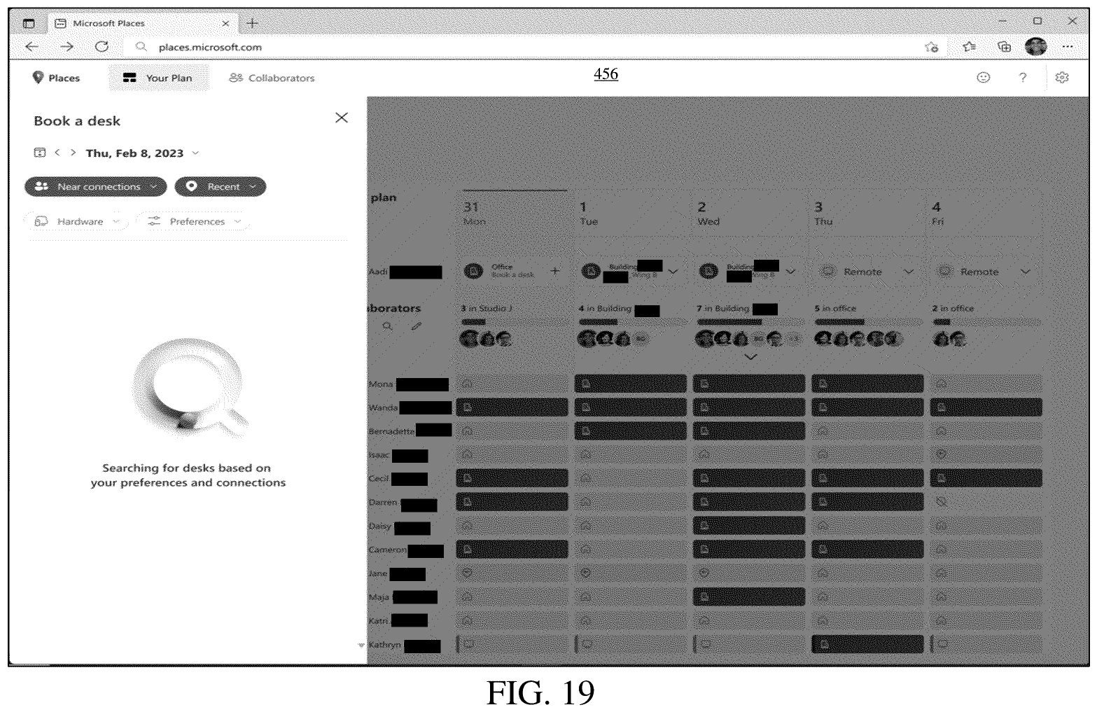

FIG. 18 shows another example of a user interface display 450. Display 450 shows calendar section 366, and date selector 452, as well as the user's agenda for a selected date illustrated at 454. In the example shown in FIG. 18, the user illustratively actuates date selector 452 and selects another day (e.g., Thursday, Feb. 8, 2023) at which point the system begins searching for desks based on the user preferences and user connections (e.g., collaborators, etc.). One example of a user interface display illustrating this is indicated by 456 in FIG. 19.

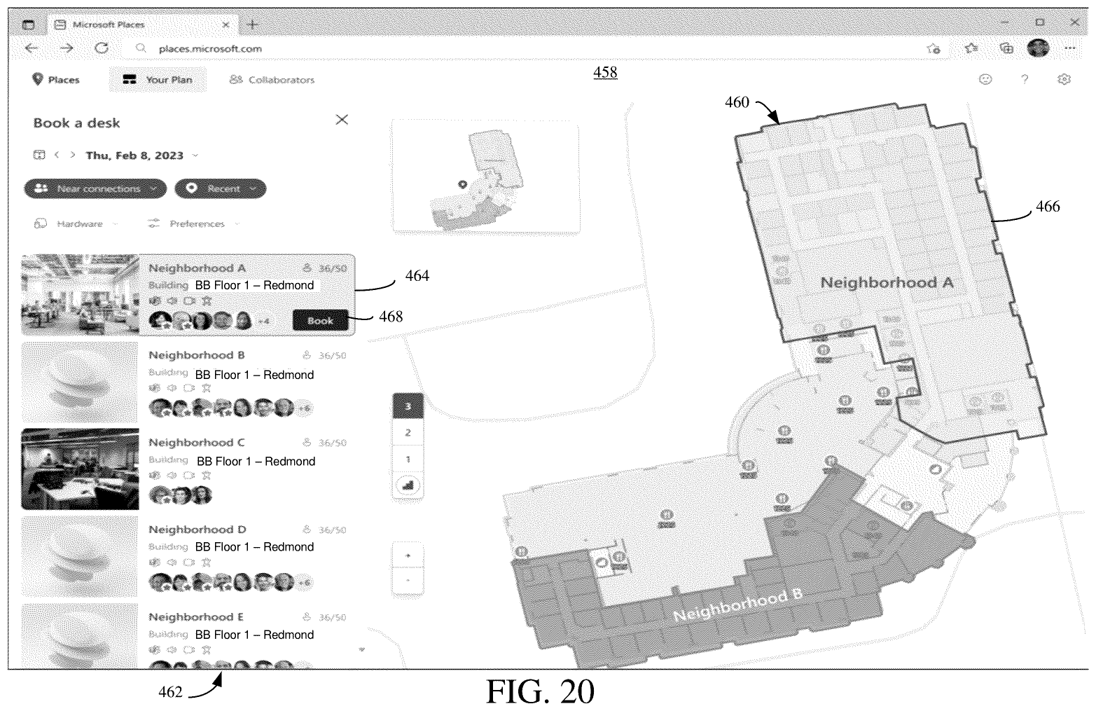

Once available desks are located, the available desks are grouped by desk pool (or neighborhood) and displayed to the user, as illustrated by user interface display 458 shown in FIG. 20. It can be seen that a map display section 460 shows different desk pools (or neighborhoods), which have availability and which are ranked based upon the number of collaborators in each neighborhood. The different options for booking are shown in display panel 462 where each of a plurality of different user actuatable display elements correspond to a different desk pool (or neighborhood) labeled as neighborhoods A-E in FIG. 20. When the user selects one of the user actuatable elements, the corresponding neighborhood is indicated on map display section 460. For instance, in FIG. 20, the user has selected actuatable display element 464 corresponding to neighborhood A. FIG. 20 also shows that map portion 460 now highlights neighborhood A by outlining it as shown at 466. Of course, it will be appreciated that the selected neighborhood can be highlighted using other visual indica, such as shading, etc. Once a user actuatable element (e.g., user actuatable element 464) is selected by the user, a book actuator 468 is also displayed which can be actuated by the user to reserve a desk in the selected desk pool or neighborhood.

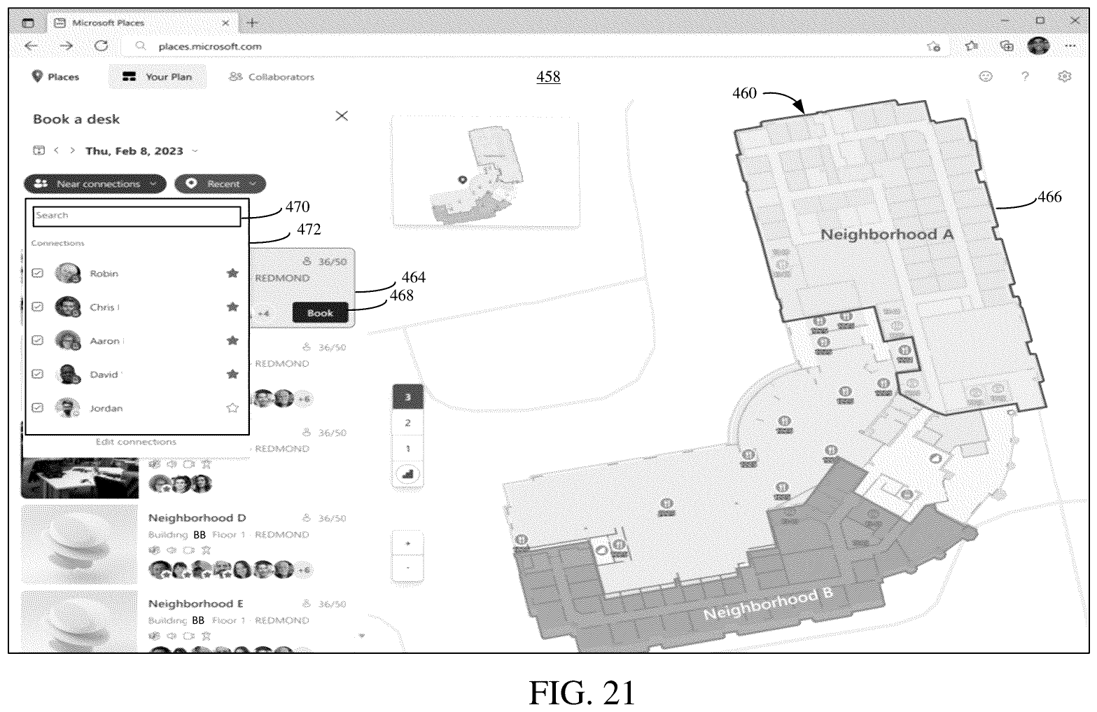

FIG. 21 is similar to FIG. 20, and similar items are similar numbered. However, FIG. 21 also shows that the user can actuate an actuator on display 458 to have a user actuatable search mechanism 470 displayed. In the example shown in FIG. 21, mechanism 470 is a text box which allows the user to enter a search term. In one example, a dropdown menu 472 is also displayed which shows a number of the user's collaborators (or connections). If the user selects one of the collaborators or connections from dropdown menus 472, the system will preferentially search for a neighborhood or desk pool at which the selected collaborator or connection is booked.

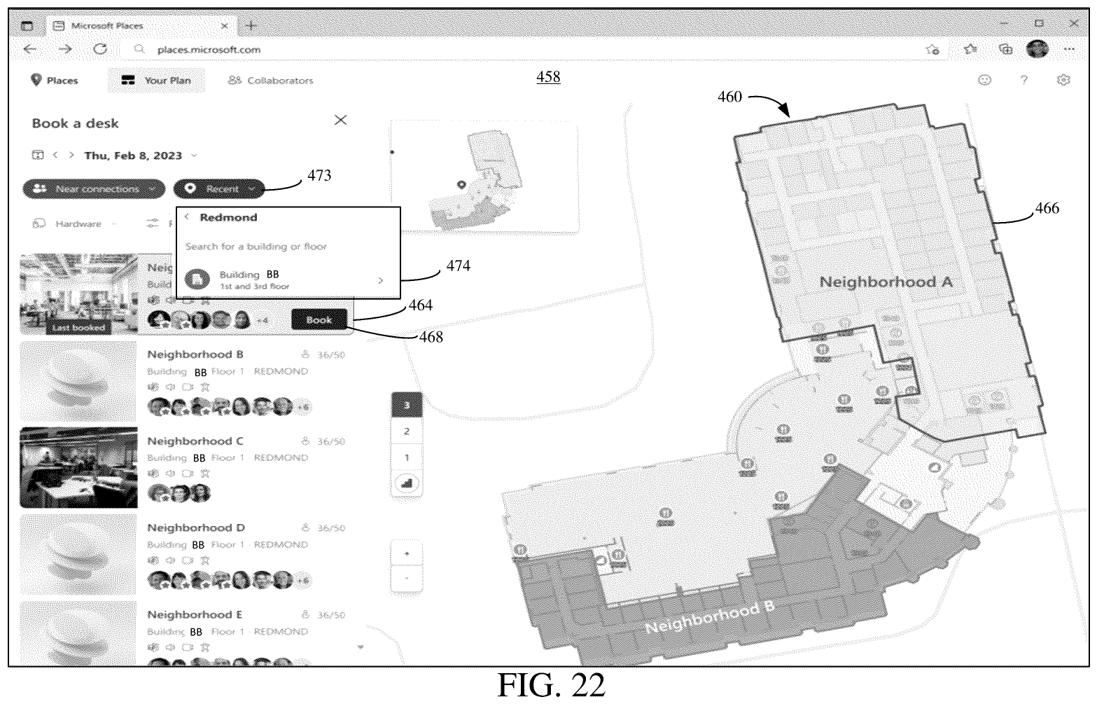

FIG. 22 is similar to FIG. 20 and similar items are similarly numbered. However, FIG. 22 shows that the user has actuated a “recent” actuator 473. In response, the system displays a dropdown display 474 showing recent desk pools or neighborhoods in which the user has booked desks. Each item on display 474 can be actuatable by the user to see more information about the corresponding desk pool or neighborhood, such as which of the user's collaborators or connections have reservations there, etc.

It can thus be seen that the present description has described a system which reduces network bandwidth and computing resources needed to book reservations at an office location. The present description generates a list of suggestions, based upon collaborators of a user who already have reservations, based upon location data, and based on historical data, to increase the likelihood that a suggestion will be accepted by the user. This reduces network bandwidth in that a user need not perform multiple searches, in order to find a suitable location before reserving that location.

It will be noted that the above discussion has described a variety of different systems, components, generators, identifiers, and/or logic. It will be appreciated that such systems, components, generators, identifiers, and/or logic can be comprised of hardware items (such as processors and associated memory, or other processing components, some of which are described below) that perform the functions associated with those systems, components, generators, identifiers, and/or logic. In addition, the systems, components, generators, identifiers, and/or logic can be comprised of software that is loaded into a memory and is subsequently executed by a processor or server, or other computing component, as described below. The systems, components, generators, identifiers, and/or logic can also be comprised of different combinations of hardware, software, firmware, etc., some examples of which are described below. These are only some examples of different structures that can be used to form the systems, components, generators, identifiers, and/or logic described above. Other structures can be used as well.

The present discussion has mentioned processors and servers. In one example, the processors and servers include computer processors with associated memory and timing circuitry, not separately shown. They are functional parts of the systems or devices to which they belong and are activated by, and facilitate the functionality of the other components or items in those systems.

Also, a number of user interface (UI) displays have been discussed. The UI display can take a wide variety of different forms and can have a wide variety of different user actuatable input mechanisms disposed thereon. For instance, the user actuatable input mechanisms can be text boxes, check boxes, icons, links, drop-down menus, search boxes, etc. The mechanisms can also be actuated in a wide variety of different ways. For instance, the mechanisms can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which the mechanisms are displayed is a touch sensitive screen, the mechanisms can be actuated using touch gestures. Also, where the device that displays them has speech recognition components, the mechanisms can be actuated using speech commands.

A number of data stores have also been discussed. It will be noted the data stores can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

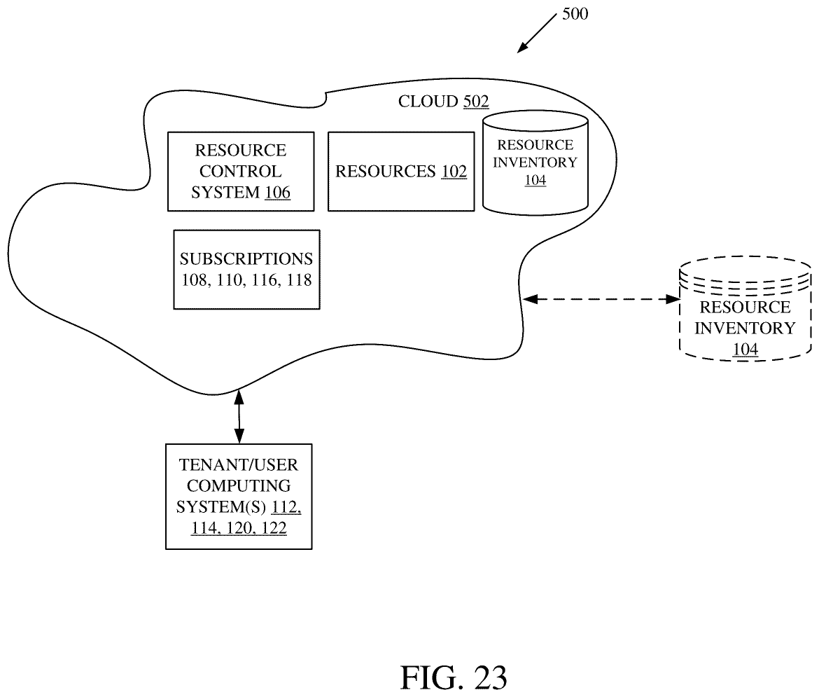

FIG. 23 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various examples, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 23, some items are similar to those shown in FIG. 1 and they are similarly numbered. FIG. 23 specifically shows that data 104 and systems 102 and 106 can be located in cloud 502 (which can be public, private, or a combination where portions are public while others are private). Therefore, users 110 and 114 use user devices 504 and 506 to access those systems through cloud 502.

FIG. 23 also depicts another example of a cloud architecture. FIG. 23 shows that it is also contemplated that some elements of computing system architecture 100 can be disposed in cloud 502 while others are not. By way of example, data store 147 can be disposed outside of cloud 502, and accessed through cloud 502. Regardless of where the items are located, the items can be accessed directly by devices 504 and 506, through a network (either a wide area network or a local area network), the items can be hosted at a remote site by a service, or the items can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

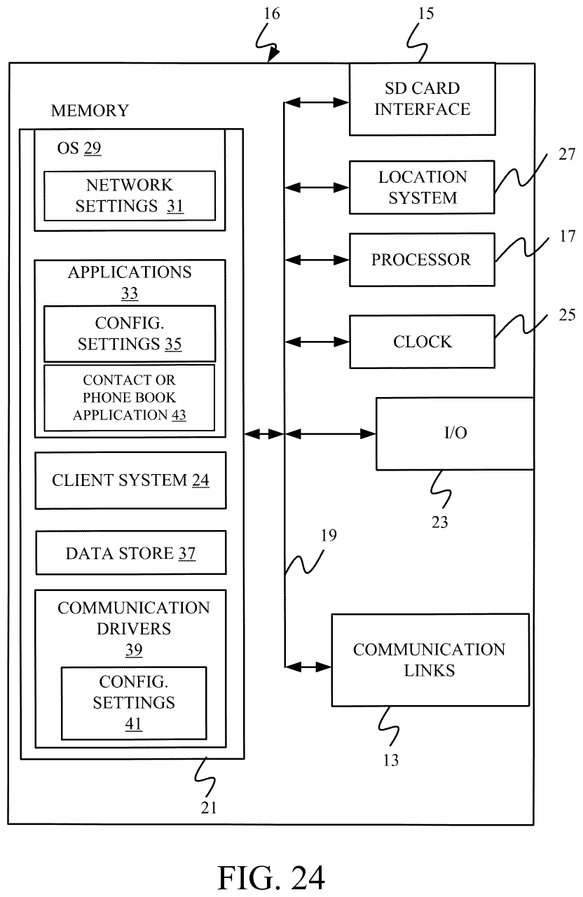

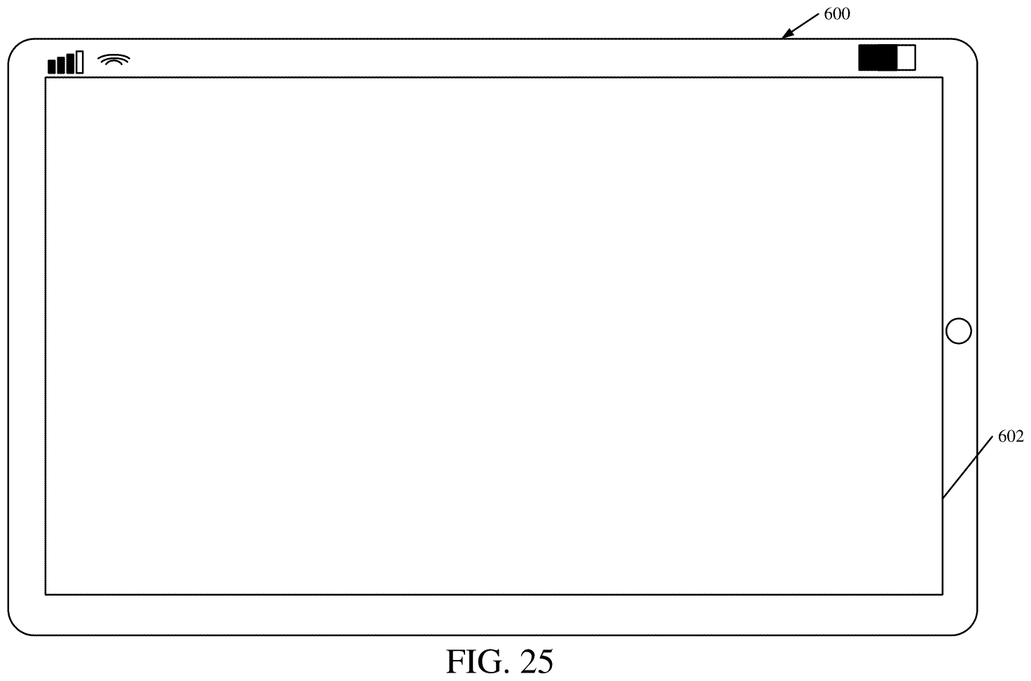

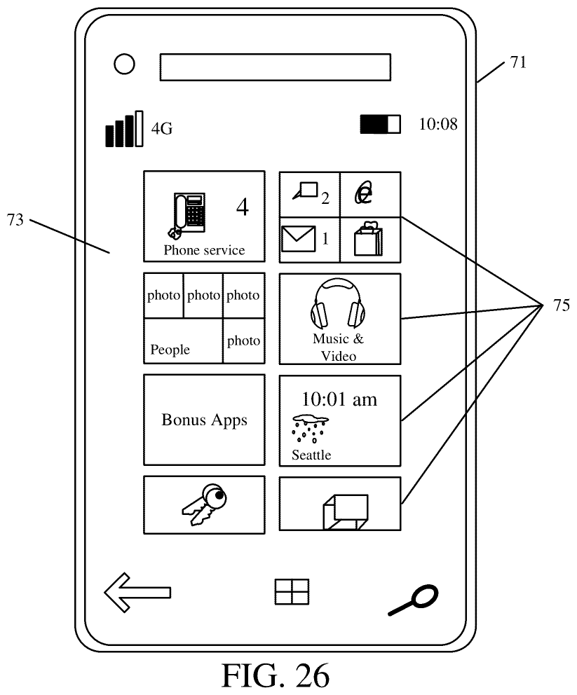

FIG. 24 is a simplified block diagram of one illustrative example of a handheld or mobile computing device that can be used as a user's or client's hand held device 16, in which the present system (or parts of it) can be deployed. FIGS. 25-26 are examples of handheld or mobile devices.

FIG. 24 provides a general block diagram of the components of a client device 16 that can run components computing system architecture 100 or user devices 504 and 506 or that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as Wi-Fi protocols, and Bluetooth protocol, which provide local wireless connections to networks.

In other examples, applications or systems are received on a removable Secure Digital (SD) card that is connected to a SD card interface 15. SD card interface 15 and communication links 13 communicate with a processor 17 (which can also embody processors or servers from other FIGS.) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a dead reckoning system, a cellular triangulation system, or other positioning system. Location system 27 can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. Memory 21x can also include computer storage media (described below). Memory 21 stores computer readable instructions that, when executed by processor 17, cause the processor to perform computer-implemented steps or functions according to the instructions. Similarly, device 16 can have a client system 24 which can run various applications or embody parts or all of architecture 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 25 shows one example in which device 16 is a tablet computer 600. In FIG. 25, computer 600 is shown with user interface display screen 602. Screen 602 can be a touch screen (so touch gestures from a user's finger can be used to interact with the application) or a pen-enabled interface that receives inputs from a pen or stylus. Computer 600 can also use an on-screen virtual keyboard. Of course, computer 600 might also be attached to a keyboard or other user input device through a suitable attachment mechanism, such as a wireless link or USB port, for instance. Computer 600 can also illustratively receive voice inputs as well.

FIG. 26 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

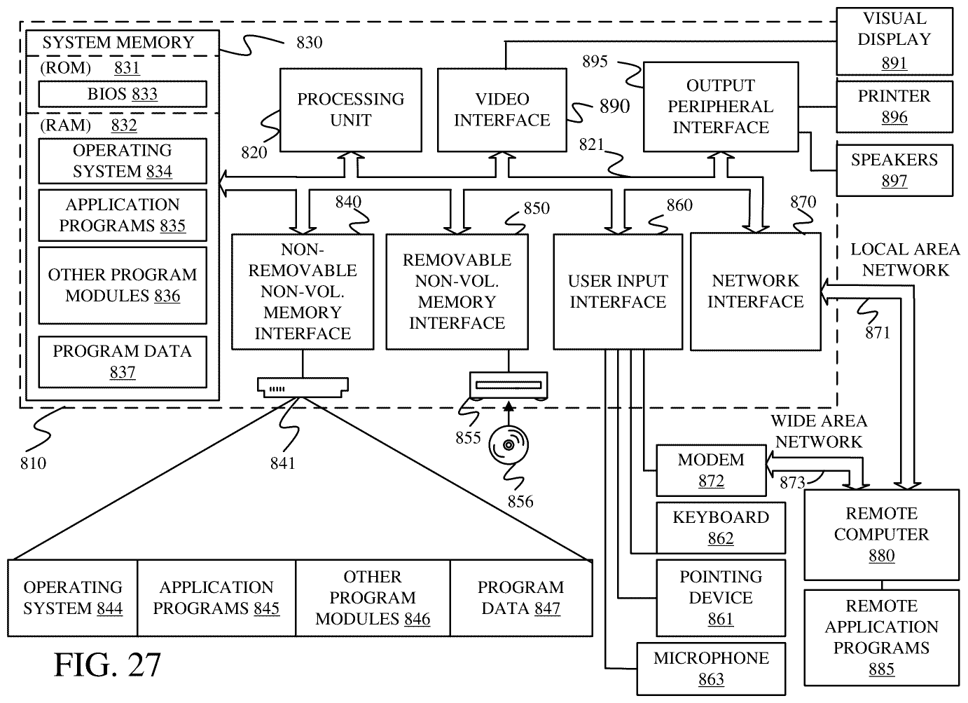

FIG. 27 is one example of a computing environment in which architecture 100, or parts of it, (for example) can be deployed. With reference to FIG. 27, an example system for implementing some embodiments includes a computing device in the form of a computer 810 programmed to operate as described above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 27.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. Computer storage media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 27 illustrates operating system 834, application programs 835, other program modules 836, and program data 837.

The computer 810 may also include other removable/non-removable volatile/nonvolatile computer storage media. By way of example only, FIG. 27 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 27, provide storage of computer readable instructions, data structures, program modules and other data for the computer 810. In FIG. 27, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 27 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 27 illustrates remote application programs 885 as residing on remote computer 880. It will be appreciated that the network connections shown are exemplary and other means of establishing a communications link between the computers may be used.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method, comprising:
identifying a collaborator corresponding to a user;
accessing work location information for the collaborator, the work location information being indicative of a work location where the collaborator is scheduled to work;
generating a collaborator-based suggestion indicative of a first suggested work location based on the work location of the collaborator;
identifying a user location;
generating a location-based suggestion indicative of a second suggested work location based on the user location; and
generating a suggestion output including a first suggestion element indicative of the collaborator-based suggestion and a second suggestion element indicative of the location-based suggestion.

2. The computer implemented method of claim 1 wherein generating the suggestion output comprises:
generating the first suggestion element as a first user-actuatable suggestion element; and
generating the second suggestion element as a second user-actuatable suggestion element.

3. The computer implemented method of claim 2 and further comprising:
detecting user actuation of one of the first and second user-actuatable selection elements, to identify an actuated suggestion element;
generating a detailed suggestion output identifying collaborators of the user who are scheduled to work at the work location corresponding to the actuated suggestion element; and
generating a reservation actuator.

4. The computer implemented method of claim 3 and further comprising:
detecting user actuation of the reservation actuator; and
interacting with a reservation system to generate a reservation for the user to reserve a seat at the work location corresponding to the actuated suggestion elements.

5. The computer implemented method of claim 1 wherein identifying a collaborator comprises identifying a plurality of collaborators of the user and wherein accessing work location information corresponding to the collaborator comprises accessing work location information corresponding to each of the plurality of collaborators, the work location information corresponding to each of the plurality of collaborators being indicative of a work location where the corresponding collaborator is scheduled to work.

6. The computer implemented method of claim 5 wherein generating a collaborator-based suggestion comprises:
identifying a first number of collaborators, of the plurality of collaborators, that share a first common work location; and
generating a first collaborator-based suggestion based on the first number of collaborators that share the first common work location.

7. The computer implemented method of claim 6 wherein generating the collaborator-based suggestion comprises:
identifying a second number of collaborators, of the plurality of collaborators, that share a second common work location; and
generating a second collaborator-based suggestion based on the second number of collaborators that share the second common work location.

8. The computer implemented method of claim 7 wherein generating the collaborator-based suggestion comprises:
ranking the first collaborator-based suggestion and the second collaborator-based suggestion based on the first number of collaborators and the second number of collaborators to obtain a ranked list of collaborator-based suggestions; and
generating the collaborator-based suggestion based on the ranked list of collaborator-based suggestions.

9. The computer implemented method of claim 8 wherein identifying a plurality of collaborators comprises:
ranking the plurality of collaborators based on ranking criteria to obtain a rankled list of collaborators.

10. The computer implemented method of claim 9 wherein ranking the first collaborator-based suggestion and the second collaborator-based suggestion comprises:
determining an identity of each collaborator, of the plurality of collaborators, that share the first common work location to obtain a first set of identified collaborators;
determining an identity of each collaborator, of the plurality of collaborators, that share the second common work location to obtain a second set of identified collaborators; and
ranking the first collaborator-based suggestion and the second collaborator-based suggestion based on the first set of identified collaborators, the second set of identified collaborators, and the ranked list of collaborators, to obtain a ranked list of collaborator-based suggestions.

11. The computer implemented method of claim 8 wherein generating a location-based suggestion comprises:
identifying a first available work location based on the user location;
identifying a second available work location based on the user location;
generating a first location-based suggestion corresponding to the first available work location; and
generating a second location-based suggestion corresponding to the second available work location.

12. The computer implemented method of claim 11 wherein generating a location-based suggestion comprises
identifying a first level of availability at the first available work location;
identifying a second level of availability at the second available work location;
ranking the first location-based suggestion and the second location-based suggestion based on the first level of availability and the second level of availability to obtain a ranked list of location-based suggestions; and
generating the location-based suggestion based on the ranked list of location-based suggestions.

13. The computer implemented method of claim 12 and further comprising:
accessing historical reservation data corresponding to the user to identify historical locations and historical collaborators corresponding to the user;
prior to generating the collaborator-based suggestion based on the ranked list of collaborator-based suggestions, re-ranking the ranked list of collaborator-based suggestions based on the identified historical collaborators; and
prior to generating the location-based suggestion based on the ranked list of location-based suggestions, re-ranking the ranked list of location-based suggestions based on the identified historical locations.

14. A computer system, comprising:
at least one processor;
a collaborator-based suggestion system, implemented by the at least one processor, configured to identify a collaborator corresponding to a user, access desk pool reservation information for the collaborator indicative of a desk pool where the collaborator has reserved a desk, and generate a collaborator-based suggestion indicative of a first suggested desk pool based on the desk pool where the collaborator has reserved the desk;
a location-based suggestion system, implemented by the at least one processor, configured to identify a user location, access the desk pool information to identify a location of a second desk pool based on the user location and generate a location-based suggestion indicative of the second desk pool;
an output generator, implemented by the at least one processor, configured to generating a suggestion output including a first suggestion element indicative of the collaborator-based suggestion and a second suggestion element indicative of the location-based suggestion; and
a user interaction processor, implemented by the at least one processor, configured to access a desk reservation system based on user interaction with the suggestion output.

15. The computer system of claim 14 wherein the collaborator-based suggestion system comprises:
a collaboration identification processor configured to identify a plurality of collaborators of the user; and
a desk pool reservation identifier configured to access the desk pool reservation information for each of the plurality of collaborators to identify a desk pool where each of the plurality of collaborators has reserved a desk.

16. The computer system of claim 15 wherein the desk pool reservation identifier is configured to identify a first number of collaborators, of the plurality of collaborators, that share a first common desk pool and to identify a second number of collaborators, of the plurality of collaborators, that share a second common desk pool, and wherein the collaborator-based suggestion system comprises:
a desk pool sorting system configured to rank the first and second desk pools based on the first number of collaborators and the second number of collaborators to obtain a ranked list of collaborator-based desk pools; and
a collaborator-based suggestion generator configured to generate the collaborator-based suggestion based on the ranked list of collaborator-based desk pools.

17. The computer system of claim 16 wherein the location-based suggestion system comprises:
a location-based desk pool identifier configured to identify a first available desk pool, and a first level of availability corresponding to the first available desk pool, based on the user location and to identify a second available desk pool, and a second level of availability corresponding to the second available desk pool, based on the user location;
an availability-based sorting system configured to rank the first available desk pool and the second available desk pool based on the first level of availability and the second level of availability to obtain a ranked list of location-based desk pools; and
a location-based suggestion generator configured to generate the location-based suggestion based on the ranked list of location-based desk pools.

18. The computer system of claim 17 and further comprising a history accessing system configured to access historical reservation data corresponding to the user to identify historical desk pools where the user reserved a desk and historical collaborators with whom the user reserved a desk pool, and further comprising:
a suggestion merging and ranking system configured to re-rank the ranked list of collaborator-based desk pools based on the identified historical collaborators and to re-rank the ranked list of location-based desk pools based on the identified historical locations.

19. A computer implemented method, comprising:
identifying a first user related to a second user;
accessing a work resource identifier for the first user, the work resource identifier identifying a first work resource reserved by the first user;
generating a user-based suggestion based on the work resource identifier;
identifying a user location corresponding to the second user and a resource location corresponding to a second work resource;
generating a resource location-based suggestion indicative of a second work resource based on the user location and the resource location; and
generating a suggestion output including a first suggestion element indicative of the user-based suggestion and a second suggestion element indicative of the resource location-based suggestion.

20. The computer implemented method of claim 19 wherein identifying the first user comprises:
accessing collaborator data identifying relationships among users; and
identifying the first user based on the collaborator data.
